(19) United States
(12) Patent Application Publication
(10) Pub. No.: US 2025/0279886 A1
(43) Pub. Date: Sep. 4, 2025

(54) PROCESSING SYSTEM AND METHOD RELATED TO ENCRYPTION

(71) Applicant: Wistron Corporation, New Taipei City (TW)

(72) Inventors: Meng-Chao Kao, New Taipei City (TW); Chiy Ferng Perng, New Taipei City (TW); Tzu-Chiang Shen, New Taipei City (TW); Cheng Jhih Shih, Taipei (TW); Shih Hao Hung, Taipei (TW)

(73) Assignee: Wistron Corporation, New Taipei City (TW)

(21) Appl. No.: 18/657,718

(22) Filed: May 7, 2024

(30) Foreign Application Priority Data
Feb. 29, 2024 (TW) 113107218

(51) Int. Cl. H04L 9/30; G06F 17/14; G06F 17/16; H04L 9/00

(52) U.S. Cl. CPC H04L 9/3093; G06F 17/142; G06F 17/16; H04L 9/008

(57) ABSTRACT

A processing system and method related to encryption are provided. The processing system includes multiple computing circuits. A memory stores data. The computing circuit performs a number theoretic transform (NTT) calculation on a polynomial. A matrix multiplication calculation is performed on the polynomial through the NTT calculation. Therefore, the computing efficiency of encryption or decryption can be improved.

### CROSS-REFERENCE TO RELATED APPLICATION

This application claims the priority benefit of Taiwan application serial no. 113107218, filed on Feb. 29, 2024. The entirety of the above-mentioned patent application is hereby incorporated by reference herein and made a part of this specification.

### BACKGROUND

### Technical Field

The disclosure relates to a cryptographic technology, and in particular to a processing system and method related to encryption.

### Description of Related Art

Today, data privacy and security issues have attracted much attention, especially when business data is stored in a hybrid multi-cloud environment and faces diverse security risks. However, there is an issue with traditional encryption methods, that is, data must be first decrypted before computation and analysis can be performed, which may lead to leakage of confidentiality during the process. In this case, the fully homomorphic encryption (FHE) technology has become a very promising solution.

Fully homomorphic encryption is a special encryption technology that allows calculations to be performed in an encrypted state and various operations to be executed on ciphertext without decrypting the ciphertext, which means that the calculations may be executed on encrypted data, and an obtained result is also encrypted. Only a person with a corresponding decryption key can decrypt the final result.

The main features of fully homomorphic encryption include:
Additive homomorphism: allow an addition operation to be performed on encrypted numbers, and an obtained result is still in an encrypted form without the need for decryption.
Multiplicative homomorphism: allow a multiplication computation to be performed on encrypted numbers, and an obtained result is still in an encrypted form also without the need for decryption.
Fully homomorphic: support both additive and multiplicative homomorphism, allowing an arbitrarily complex calculation on encrypted data without the need for decryption.

Solutions to achieve fully homomorphic encryption include but are not limited to Rivest-Shamir-Adleman (RSA) homomorphic encryption, Gentry's fully homomorphic encryption over the integers, Brakerski-Gentry-Vaikuntanathan (BGV) fully homomorphic encryption scheme, etc. It is worth noting that the RSA only has “multiplicative” homomorphism, but does not have “additive” homomorphism, so the RSA is a partially homomorphic encryption (PHE).

Although fully homomorphic encryption provides strong privacy protection and security, computing costs are usually high, resulting in relatively slow encryption and decryption processes while requiring a large amount of computing resources. Therefore, in practical applications, fully homomorphic encryption is still in the research and development stage and is being continuously improved to improve efficiency and effectiveness.

The existing fully homomorphic encryption technology still has many limitations in practical applications. For example, one of the major issues is computing efficiency. The traditional fully homomorphic encryption technology requires repeated decryption and encryption of data, introducing additional time and computing costs during the computing process. The inefficiency of such a computing manner becomes particularly obvious in scenarios such as real-time data processing, cloud computing, and the Internet of Things.

### SUMMARY

The disclosure provides a processing system and method related to encryption, which can improve the computing efficiency of a homomorphic computation, encryption, and decryption.

A processing system related to encryption of an embodiment of the disclosure includes (but is not limited to) multiple computing circuits. A memory stores data. The computing circuit performs a fast number theoretic transform (NTT) calculation on a polynomial. A matrix multiplication calculation is performed on the polynomial through the fast number theoretic transform calculation.

A method related to encryption of an embodiment of the disclosure includes (but is not limited to) the following steps. A fast number theoretic transform calculation is performed on a polynomial through multiple computing circuits. A matrix multiplication calculation is performed on the polynomial through the fast number theoretic transform calculation.

In order for the features and advantages of the disclosure to be more comprehensible, the following specific embodiments are described in detail in conjunction with the drawings.

### BRIEF DESCRIPTION OF THE DRAWINGS

FIG. 1 is an element block diagram of a processing system according to an embodiment of the disclosure.

FIG. 2 is a schematic diagram of a butterfly computation according to an embodiment of the disclosure.

FIG. 3 is a system architecture diagram of two-dimensional fast number theoretic transform according to an embodiment of the disclosure.

FIG. 4A is a schematic diagram illustrating a butterfly computation according to an embodiment of the disclosure.

FIG. 4B is a schematic diagram illustrating a multiplication computation with a twiddle factor according to an embodiment of the disclosure.

FIG. 4C is a schematic diagram illustrating factor position swapping according to an embodiment of the disclosure.

FIG. 5A to FIG. 5C are schematic diagrams illustrating one-dimensional fast number theoretic transform according to an embodiment of the disclosure.

FIG. 6A to FIG. 6D are schematic diagrams illustrating two-dimensional fast number theoretic transform according to an embodiment of the disclosure.

FIG. 7 is a system architecture diagram of three-dimensional fast number theoretic transform according to an embodiment of the disclosure.

FIG. 8A is a schematic diagram illustrating a multiplication computation with a twiddle factor according to an embodiment of the disclosure.

FIG. 8B is a schematic diagram illustrating memory address change according to an embodiment of the disclosure.

FIG. 9A to FIG. 9F are schematic diagrams illustrating three-dimensional fast number theoretic transform according to an embodiment of the disclosure.

FIG. 10 is a system architecture diagram of four-dimensional fast number theoretic transform according to an embodiment of the disclosure.

FIG. 11A to FIG. 11F are schematic diagrams illustrating four-dimensional fast number theoretic transform according to an embodiment of the disclosure.

FIG. 12 is a system architecture diagram of non-pipelined fast number theoretic transform according to an embodiment of the disclosure.

FIG. 13 is a schematic diagram illustrating data storage according to an embodiment of the disclosure.

FIG. 14A is a schematic diagram illustrating forward fast number theoretic transform according to an embodiment of the disclosure.

FIG. 14B is a schematic diagram illustrating non-pipelined fast number theoretic transform according to an embodiment of the disclosure.

FIG. 15 is a flowchart of an encryption method according to an embodiment of the disclosure.

### DESCRIPTION OF THE EMBODIMENTS

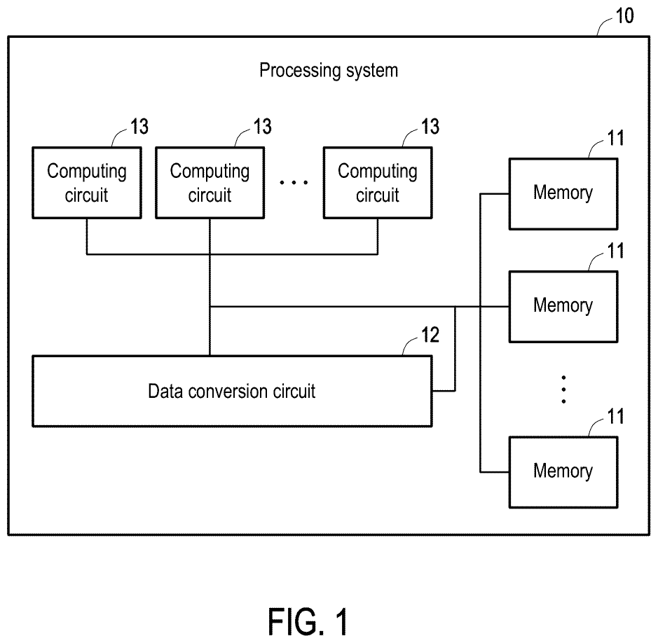

FIG. 1 is a block diagram of a processing system 10 according to an embodiment of the disclosure. Please refer to FIG. 1. The processing system 10 includes (but is not limited to) one or more memories 11, a data conversion circuits 12, and multiple computing circuits 13.

The processing system 10 may be an electronic device such as a server, a desktop computer, a notebook computer, a smart phone, a tablet computer, a wearable device, a vehicle-mounted device, or a smart home appliance, or may be a central processing unit (CPU), a graphics processing unit (GPU), a programmable general-purpose or specific-purpose microprocessor, a digital signal processor (DSP), a programmable controller, a field programmable gate array (FPGA), an application-specific integrated circuit (ASIC), a computing accelerator, other similar elements, or a combination of the above elements.

The memory 11 may be any type of fixed or removable random access memory (RAM), read only memory (ROM), or similar elements. In an embodiment, the memory 11 is used to store program codes, software modules, configurations, data (for example, factors, algorithms, matrices, or parameters), or files, and an embodiment thereof will be described in detail later.

The data conversion circuit 12 is coupled to the memory 11. The data conversion circuit 12 may be various types of processors, controllers, processing elements (PE), processing cores, FPGA, ASIC, or other digital circuits.

The computing circuit 13 is coupled to the memory 11 and the data conversion circuit 12. The computing circuit 13 may be various types of processors, controllers, processing elements, processing cores, FPGA, ASIC, or other digital circuits.

In the following, the embodiments of the disclosure will be further explained below in conjunction with various devices, elements, and modules in the processing system 10. Each process of the embodiments of the disclosure may be adjusted according to the implementation situation.

The main concept of fully homomorphic encryption is to perform a computation on ciphertext to obtain an encrypted result, and a result obtained by decrypting the encrypted result is consistent with a result of performing the same computation on plaintext. It is worth noting that the basic computation of fully homomorphic encryption usually involves a multiplication computation of a polynomial. Fast number theoretic transform (NTT) is an algorithm that implements polynomial multiplication. A matrix multiplication calculation may be performed on a polynomial through a fast number theoretic transform calculation. Fast number theoretic transform is the fast Fourier transform (FFT) in integer form. Fast number theoretic transform may reduce the original time complexity of degree N polynomial multiplication from O(N\hat{ }2) to O(NlogN). For example, fast number theoretic transform converts a polynomial computation into a point computation in a fast number theoretic transform domain, thereby greatly improving computing efficiency.

The mathematical expression of fast number theoretic transform may be:

$${X}_{j} = {\sum }_{i} {( {ω}^{j} )}^{i} {x}_{i} \qquad ( 1 )$$

where xᵢ is an i-th data vector, ω^{j} is a factor of a j-th degree N polynomial (may be presented by a matrix that records factors in the polynomial), and Xⱼ is a j-th output matrix. Equation (1) above is matrix-vector multiplication, and the matrix used may be a Vandermonde matrix.

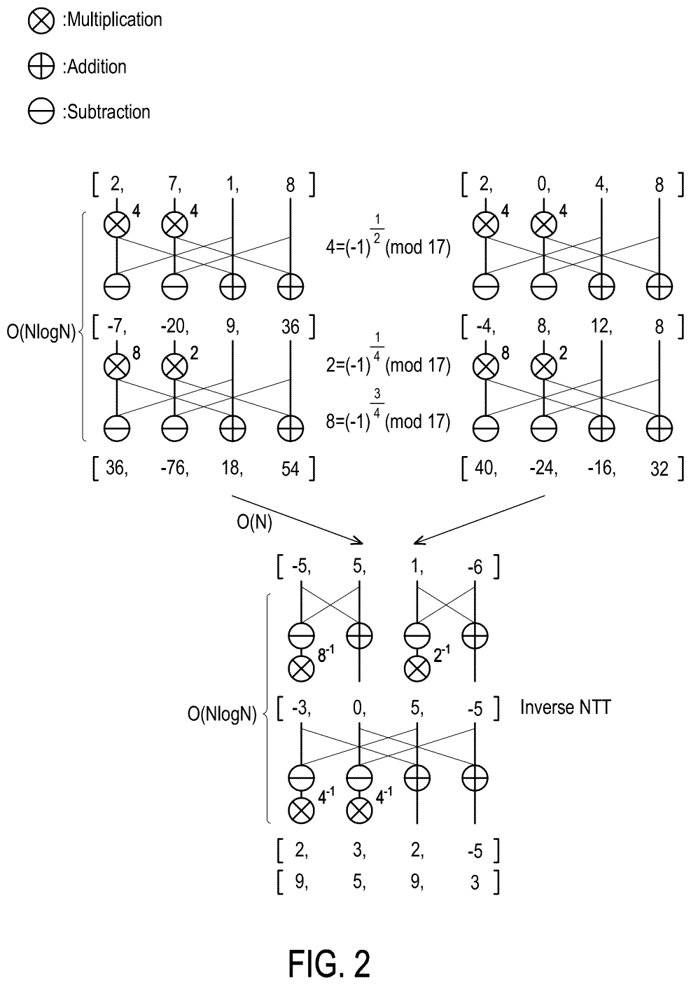

Since ω is periodic, Equation (1) above may be further simplified to only require multiplication of O(NlogN) to complete all computations. For example, FIG. 2 is a schematic diagram of a butterfly computation according to an embodiment of the disclosure. Please refer to FIG. 2. Fast number theoretic transform/fast Fourier transform may be implemented through a butterfly architecture. In the multiplication of two polynomials, 2x³+7x²+1x¹+8x⁰ and 2x³+0x²+4x¹+8x⁰, the polynomial 2x³+7x²+1x¹+8x⁰ is converted into a data vector [2, 7, 1, 8], and the polynomial 2x³+0x²+4x¹+8x⁰ is converted into a data vector [2, 0, 4, 8]. The two data vectors are first converted into the fast number theoretic transform domain via time complexity of O(NlogN), and a point multiplication computation (that is, element-wise multiplication) is performed in the fast number theoretic transform domain. The point multiplication computation only takes time complexity of O(N). Finally, time complexity of O(NlogN) is taken to convert back to the normal domain. It should be noted that in the drawing, “x” is multiplication (multiply by the factor on the side, such as 2×4), “+” is addition (add two values on a connecting line, such as (7×4)+8), and “−” is subtraction (subtract two values on a connecting line, such as (2×4)−1).

In addition, in the drawing, the polynomial x^{N}+1 is taken as an example, so FIG. 2 shows negacyclic fast number theoretic transform. The polynomial x^{N}+1 is substituted into Equation (1) to become Xⱼ=Σⱼ(ω^{2j+1})ⁱxᵢ, so ω becomes a degree 2N polynomial and may be implemented using different conversion manners.

In an embodiment, in the computation of fast number theoretic transform, there are log N stages (NlogN multiplications), and the hardware implementation includes full pipelined and non-full pipelined manners.

The full pipelined manner allocates the hardware (for example, the computing circuit 13, the memory 11, or a combination thereof) required by all stages, so more hardware resources are available for use, and there is better performance in output/cycle.

The non-pipelined manner may use the same set of hardware to implement different stages of operations, so there are fewer hardware resources available for use, but control is easier.

In an embodiment, the computing circuits 13 perform a fast number theoretic transform calculation on a polynomial. A matrix multiplication calculation is performed on the polynomial through the fast number theoretic transform calculation.

In an embodiment, the computing circuits 13 perform multi-dimensional fast number theoretic transform. The multi-dimensional fast number theoretic transform converts matrix-vector multiplication into a computation architecture of a multi-stage matrix multiplication calculation through multiple sub-computations. One computing circuit 13 performs one sub-computation, and each sub-computation is located at one stage of the multi-stage computation architecture.

The mathematical expression of multi-dimensional fast number theoretic transform is:

$${X}_{{k}_{1} , {k}_{2} , … , {k}_{d}} = {\sum }_{{n}_{1} = 0}^{{N}_{1} - 1} ( {ω}_{{N}_{1}}^{{k}_{1} {n}_{1}} {\sum }_{{n}_{2} = 0}^{{N}_{2} - 1} {ω}_{{N}_{2}}^{{k}_{2} {n}_{2}} … {\sum }_{{n}_{d} = 0}^{{N}_{d} - 1} {ω}_{{N}_{d}}^{{k}_{d} {n}_{d}} \cdot {x}_{{n}_{1} , {n}_{2} , … , {n}_{d}} ) \qquad ( 2 )$$

where Xₖ_{₁}_{, k}_{₂}_{, . . . , k}_{_{d}} is the output factor of (k₁, k₂, . . . , k_{d})-th multi-dimensional fast number theoretic transform, xₙ_{₁}_{, n}_{₂} _{, . . . n}_{_{d}} is the (n₁, n₂, . . . , n_{d})-th input matrix, ω is a twiddle factor, N₁*N₂* . . . *N_{d} is N, dis a target dimension, and N is the degree of the polynomial.

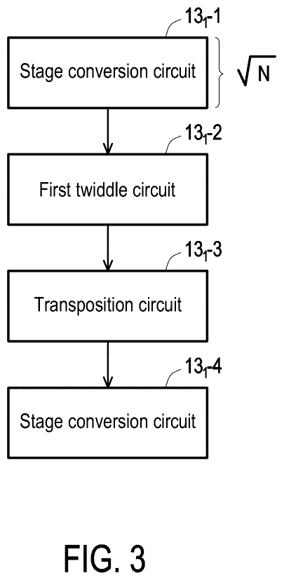

FIG. 3 is a system architecture diagram of two-dimensional fast number theoretic transform according to an embodiment of the disclosure. Please refer to FIG. 3, which shows a two-dimensional pipelined multi-dimensional fast number theoretic transform architecture. For a two-dimensional computation (d of Equation (2) is 2), the mathematical expression of multi-dimensional fast number theoretic transform is:

$${X}_{{N}_{2} {k}_{1} + {k}_{2}} = {\sum }_{{n}_{1} = 0}^{{N}_{1} - 1} {\sum }_{{n}_{2} = 0}^{{N}_{2} - 1} {{x}_{{N}_{1} {n}_{2} + {n}_{1}} ( {ω}^{2 ( {N}_{2} {k}_{1} + {k}_{2} ) + 1} )}^{{N}_{1} {n}_{2} + {n}_{1}} = {\sum }_{{n}_{1} = 0}^{{N}_{1} - 1} ( ( {\sum }_{{n}_{2} = 0}^{{N}_{2} - 1} {{x}_{{N}_{1} {n}_{2} + {n}_{1}} ( {ω}^{2 {k}_{2} + 1} )}^{{N}_{1} {n}_{2}} ) {ω}^{{n}_{1} ( 2 {k}_{2} + 1 - {N}_{2} )} ) {( {ω}^{2 {k}_{1} + 1} )}^{{N}_{2} {n}_{1}} \qquad ( 3 )$$

where X_{N}_{₂}ₖ_{₁}₊ₖ_{₂} is the output factor of (N₂k₁+k₂)-th multi-dimensional fast number theoretic transform, x_{N}_{₁}ₙ_{₂}₊ₙ_{₁} is the (N₁n₂+n₁)-th input matrix, ω is the twiddle factor, N₁*N₂ is N, and N is the degree of the polynomial.

Equation (3) may be allocated to the computing circuits 13 for implementation. The computing circuits 13 include one or more stage conversion circuits, one or more first twiddle circuits, and one or more transposition circuits. Taking FIG. 3 as an example, the computing circuits 13 with such an architecture include two stage conversion circuits 13₁-1 and 13₁-4, a first twiddle circuit 13₁-2, and a transposition circuit 13₁-3. The order of execution of the computing circuits 13 is the stage conversion circuit 13₁-1, the first twiddle circuit 13₁-2, the transposition circuit 13₁-3, and the stage conversion circuit 13₁-4.

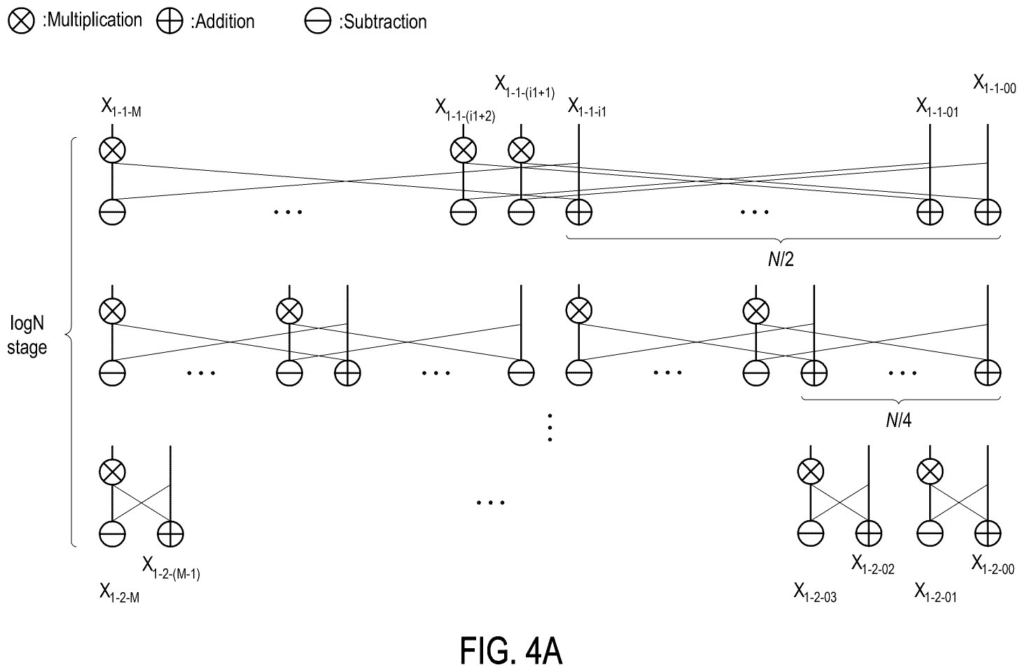

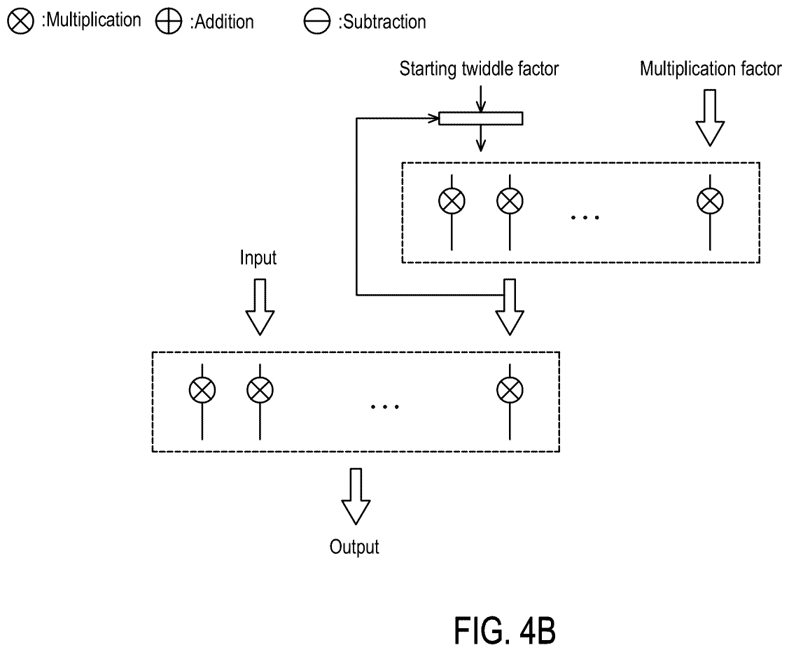

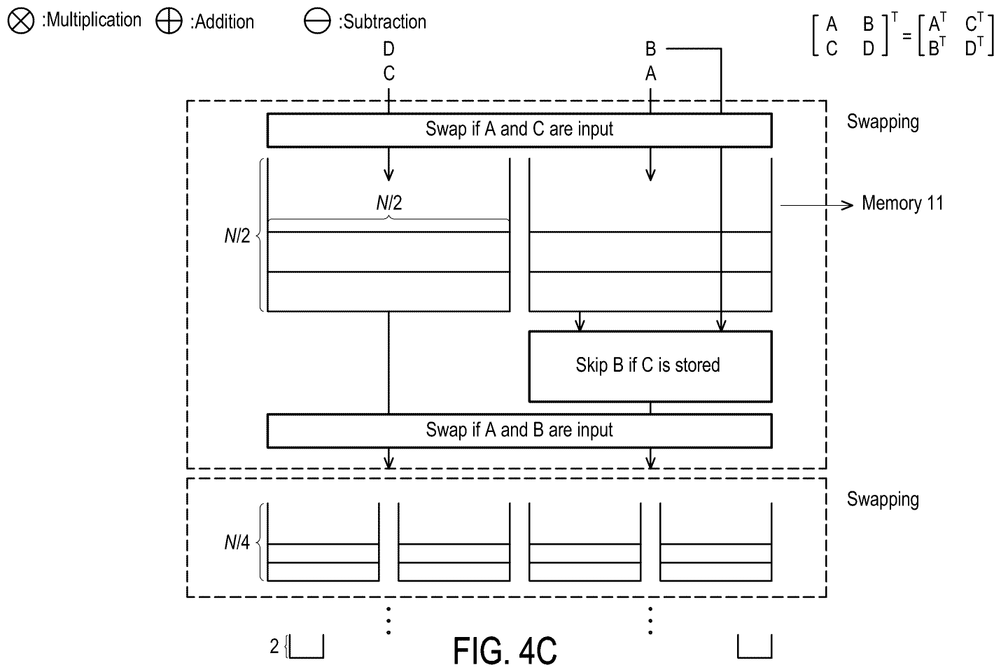

In an embodiment, the sub-computations of the stage conversion circuits 13₁-1 and 13₁-4 are butterfly computations. FIG. 4A is a schematic diagram illustrating a butterfly computation according to an embodiment of the disclosure. Please refer to FIG. 4A. A sub-stage of the butterfly computation is related to the degree (N) of the polynomial, that is, log N. In an m-th sub-stage, the butterfly computation of

$$\sqrt[d]{N} / ( {2}^{⋀} m )$$

points is performed, where d is the target dimension (two-dimensional as shown in FIG. 3, that is, d is 2). For example, in a first sub-stage, one of the outputs is x₁₋₁₋₀₀+x₁₋₁₋₍ᵢ₁₊₁₎·ω0(each multiplication “×” has a corresponding twiddle factor ω), where i1+1 is M/2+0. A data vector [x₁₋₁₋₀₀, ˜, x_{1-1-M}] has M values, and M is ^{d}\sqrt{N}. By analogy, another output is x₁₋₁₋₀₁+x₁₋₁₋₍ᵢ₁₊₂₎·ω1. The next output is x₁₋₁₋ᵢ₁+x_{1-1-M}·ω2. Finally, the output factors of a log N-th sub-stage are X₁₋₂₋₀₀, X₁₋₂₋₀₁, X₁₋₂₋₀₂, X₁₋₂₋₀₃ , . . . , X_{1-2-(M-1)}, X_{1-2-M}.

In an embodiment, the sub-computation of the first twiddle circuit 13₁-2 is a multiplication computation of the twiddle factor. FIG. 4B is a schematic diagram illustrating a multiplication computation with a twiddle factor according to an embodiment of the disclosure. Please refer to FIG. 4B. A multiplication factor is multiplied by the twiddle factor, and a multiplication result is used as a starting twiddle factor. For example, the starting twiddle factor is ω\hat{ }(n(1−N₂)), and the multiplication factor is n\hat{ }(2n), where n is 0˜N1−1}. In addition, the multiplication result is further multiplied by the input factor.

In an embodiment, the sub-computation of the transposition circuit 13₁-3 is factor position swapping. FIG. 4C is a schematic diagram illustrating factor position swapping according to an embodiment of the disclosure. Please refer to FIG. 4C. The sub-computation performs transposition on a matrix

$$[ \begin{matrix}A & B \\ C & D\end{matrix} ] ,$$

that is,

$${[ \begin{matrix}A & B \\ C & D\end{matrix} ]}^{T} = [ \begin{matrix}{A}^{T} & {C}^{T} \\ {B}^{T} & {D}^{T}\end{matrix} ] .$$

First, the positions of the matrices A and C are swapped, so that the matrix C is stored in a temporary storage area/register of the memory 11, and the matrices A and D are stored in another temporary storage area/register of the memory 11. If the matrix C is stored, storing of the matrix B will be skipped. If the matrices A and B are input at the same time, the positions of the matrices A and B will be swapped. Then, positions are swapped again. For example, if the matrices A and B are not input, the positions will not be swapped.

Please refer to FIG. 3. The data conversion circuit 12 obtains the input matrix. The column number or the row number of the input matrix is ^{d}\sqrt{N}, such as \sqrt{N}. Multiple elements of the input matrix are factors of the polynomial used for encryption, such as the factors of the polynomial related to ciphertext or plaintext used for fully homomorphic encryption. In an embodiment, the elements of the input matrix are respectively the same as multiple elements in input data (one-to-one element correspondence). The input data is also the factors of the same polynomial and is in vector form. The input data is, for example, data related to fully homomorphic encrypted ciphertext or plaintext.

In an embodiment, the data conversion circuit 12 converts the input data into the input matrix according to the target dimension. The target dimension is greater than one dimension (two dimensions in the embodiment). Therefore, the data conversion circuit 12 vectorizes the factors of the polynomial into the input data, and converts the input data into the two-dimensional input matrix. The elements in the input matrix are the elements in the input data in vector form (values thereof are the factors of the polynomial). In other words, “converting” a vector into a matrix is to allocate the elements in the input data to corresponding positions in the input matrix. For example, a first element of the input data is allocated to a first row and a first column of the input matrix.

In response to the target dimension being two-dimensional, the mathematical expression of multi-dimensional fast number theoretic transform is determined as Equation (3). Next, the butterfly computation is performed on the input matrix through the stage conversion circuit 13₁-1 of log \sqrt{N} sub-stages, the multiplication computation of the twiddle factor is performed on the output factor of the butterfly computation through the first twiddle circuit 13₁-2, factor position swapping is performed on the output factor of the multiplication computation through the transposition circuit 13₁-3, and the butterfly computation is performed on the output factor of position transposition through the stage conversion circuit 13₁-4 of log \sqrt{N} sub-stages. That is, two-dimensional multi-dimensional fast number theoretic transform is performed on the input matrix through the computing circuits 13 (that is, the two stage conversion circuits 13₁-1 and 13₁-4, the first twiddle circuit 13₁-2, and the transposition circuit 13₁-3).

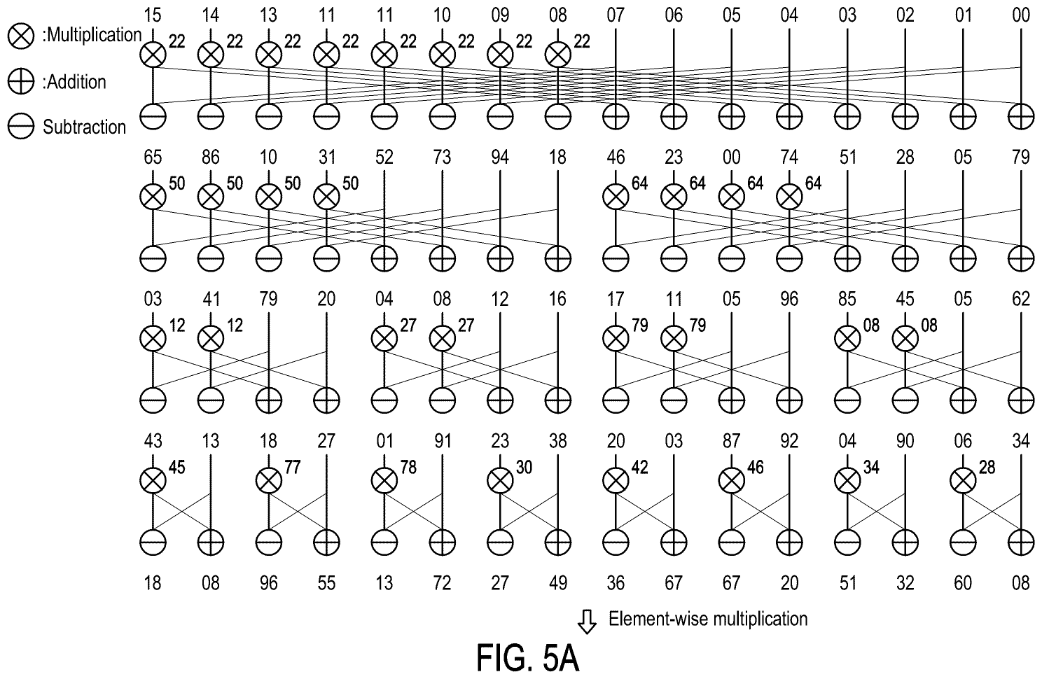

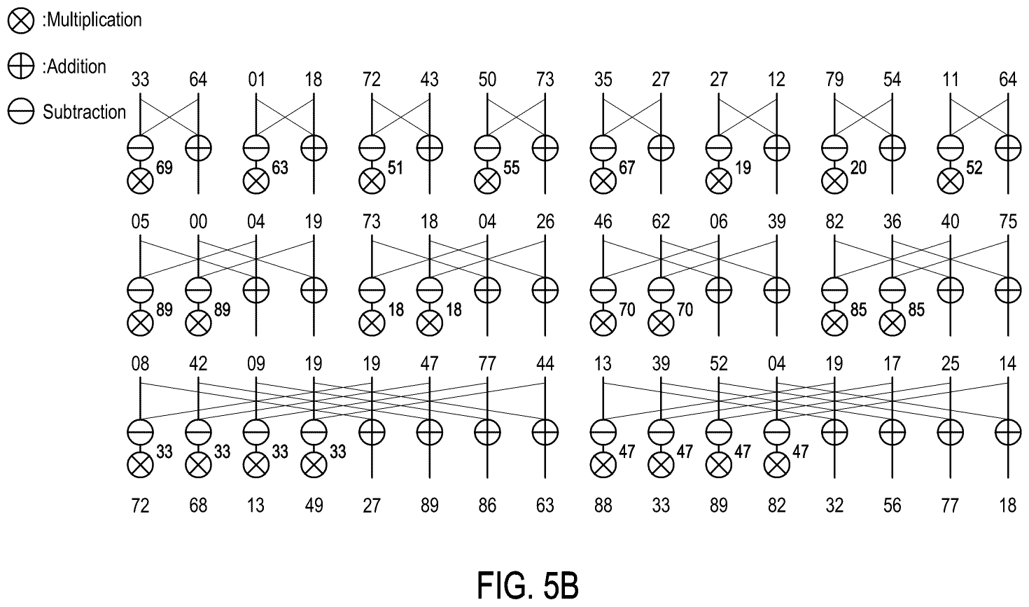

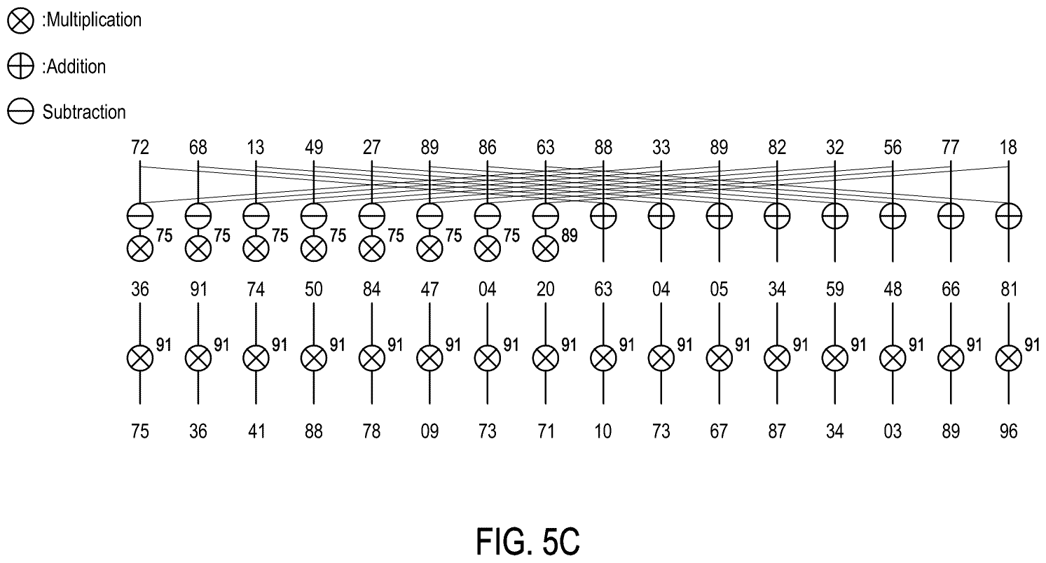

FIG. 5A to FIG. 5C are schematic diagrams illustrating one-dimensional fast number theoretic transform according to an embodiment of the disclosure. Please refer to FIG. 5A to FIG. 5C. For example, the input data is [00, 01, 02, 03, 14, 05, 06, 07, 08, 09, 10, 11, 12]. It should be noted that in the drawings, “×” is multiplication (multiply by the twiddle factor on the side, such as 15×22), “+” is addition (add two values on a connecting line, such as (15×22)+08), and “−” is subtraction (subtract two values on a connecting line, such as (15×22)−08). The twiddle factor of a first stage is (−1)\hat{ }(½) (for example, 22(mod 97)), and the twiddle factors of a second stage are (−1)\hat{ }(¼) (for example, 64 (mod 97)) and (−1)\hat{ }(¾) (for example, 50(mod 97)), and so on. Finally, the output of the input data after fast number theoretic transform is [96, 89, 34, 87, 67, 73, 10, 74, 73, 09, 78, 88, 41, 36, 75].

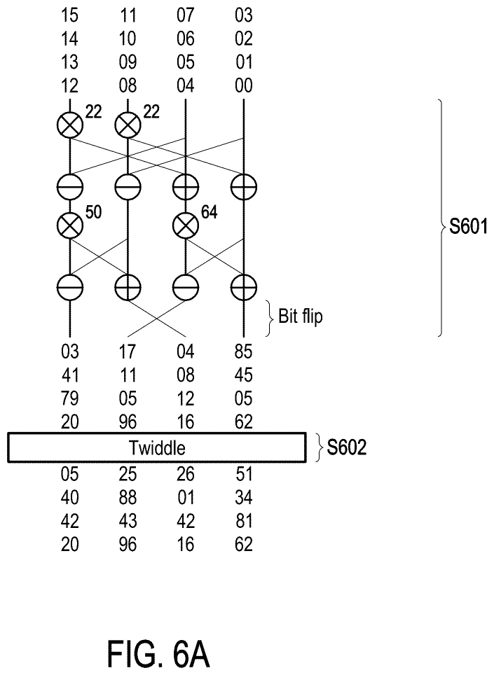

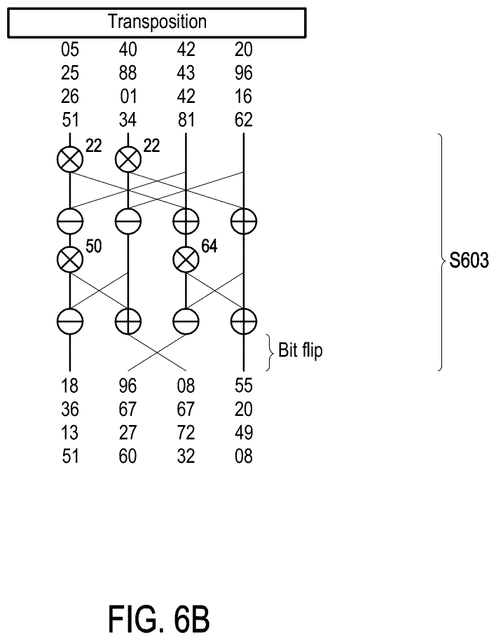

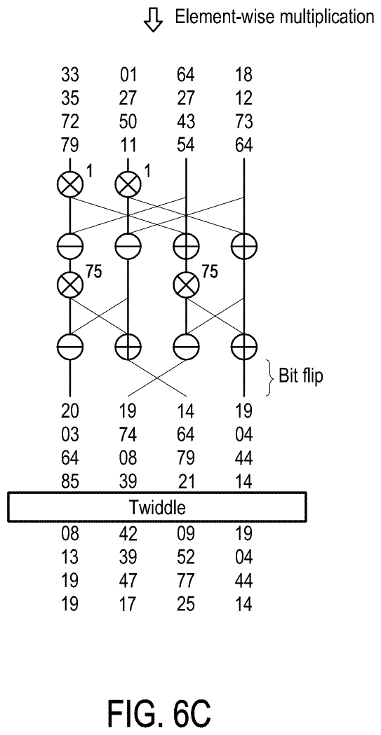

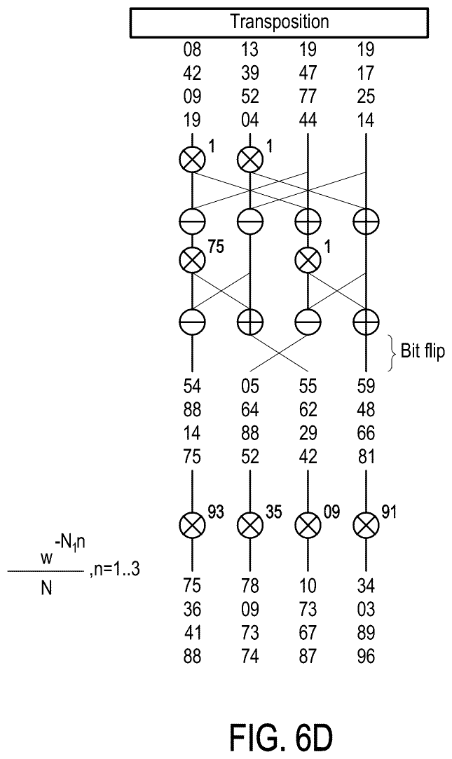

FIG. 6A to FIG. 6D are schematic diagrams illustrating two-dimensional fast number theoretic transform according to an embodiment of the disclosure. Please refer to FIG. 6A to FIG. 6D. The degree of the polynomial is N=N₁N₂(for example, N₁=N₂=\sqrt{N}). An index of the polynomial is represented by x_{N}_{₁}ₙ_{₂}₊ₙ_{₁}. An inner layer n₂ is added up to fast number theoretic transform of the first stage. ωⁿ^{₁}^{(2k}^{₂}^{+1-N}^{₂}⁾ is the twiddle factor used in the multiplication computation. An outer layer n₁ is added up to fast number theoretic transform of the second stage. The hardware architecture of FIG. 3 is suitable for implementing both forward and inverse fast number theoretic transform, and the difference is that the remaining hardware pipelined part may be shared by adding one or two additional stages of specific multiplication computations.

The data conversion circuit converts 1×16 input data into a 4×4 input matrix, such as

$$[ \begin{matrix}15 & 11 & 07 & 03 \\ 14 & 10 & 06 & 02 \\ 13 & 09 & 05 & 01 \\ 12 & 08 & 04 & 00\end{matrix} ] .$$

In Step S601, the multiplication computation is performed on the twiddle factor (ω^{2k}^{₂}⁺¹)^{N}^{₁}ⁿ^{₂}. In Step S602, the multiplication computation is performed on the twiddle factor ωⁿ^{₁}^{(2k}^{₂}^{+1-N}^{₂}⁾. In Step S603, the multiplication computation is performed on the twiddle factor (ω^{2k}^{₂}⁺¹)^{N}^{₁}ⁿ^{₂}. The “twiddle” processing in the drawings is, for example, the sub-computation shown in FIG. 4B, that is, the multiplication computation is performed on the corresponding twiddle factor. In addition, the “transposition” processing in the drawings is, for example, the sub-computation shown in FIG. 4C, that is, factor position swapping. Finally, the output matrix is

$$[ \begin{matrix}75 & 78 & 10 & 34 \\ 36 & 09 & 73 & 03 \\ 41 & 73 & 67 & 89 \\ 88 & 74 & 87 & 96\end{matrix} ] ,$$

and the values are the same as the values in the output vector of FIG. 5C (the difference is only in the positions of the matrix).

The twiddle factors in Equation (3) are ω^{2k+1} {k=0˜N₂−1} and ωⁿ^{₁}^{(2k}^{₂}^{+1-N}^{₂}⁾. In an embodiment, the twiddle factors may be prestored in the memory 11 for used in subsequent computations. In another embodiment, some or all of the twiddle factors may be generated on the fly or dynamically. For example, the twiddle factors ω^{n(1-N}^{₂}⁾ and ω²ⁿ{n=0˜N₁−1} may be computed on the fly to generate the twiddle factor ωⁿ^{₁}^{(2k}^{₂}^{+1-N}^{₂}⁾. At this time, the amount of data required to be stored is 3\sqrt{N}.

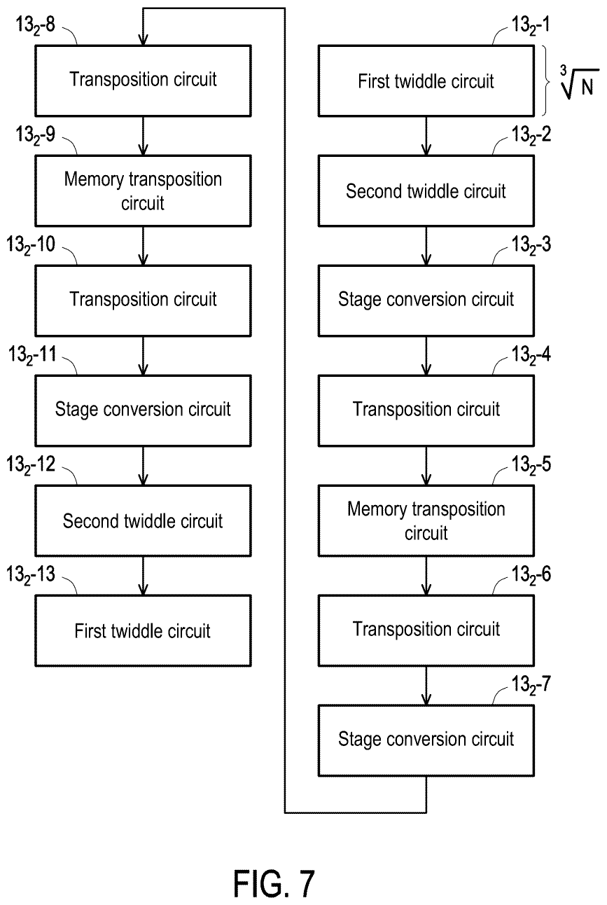

FIG. 7 is a system architecture diagram of three-dimensional fast number theoretic transform according to an embodiment of the disclosure. Please refer to FIG. 7, which shows a three-dimensional pipelined multi-dimensional fast number theoretic transform architecture. For a three-dimensional computation (d of Equation (2) is 3), the mathematical expression of multi-dimensional fast number theoretic transform is:

$${X}_{{N}_{3} {N}_{2} {k}_{1} + {N}_{3} {k}_{2} + {k}_{3}} = {\sum }_{{n}_{1} = 0}^{{N}_{1} - 1} {\sum }_{{n}_{2} = 0}^{{N}_{2} - 1} {\sum }_{{n}_{3} = 0}^{{N}_{3} - 1} {x}_{{N}_{1} {N}_{2} {n}_{3} + {N}_{1} {n}_{2} + {n}_{1}} {( {ω}^{2 ( {N}_{3} {N}_{2} {k}_{1} + {N}_{3} {k}_{2} + {k}_{3} ) + 1} )}^{{N}_{1} {N}_{2} {n}_{3} + {N}_{1} {n}_{2} + {n}_{1}} = {\sum }_{{n}_{1} = 0}^{{N}_{1} - 1} ( {\sum }_{{n}_{2} = 0}^{{N}_{2} - 1} ( \begin{matrix}( {\sum }_{{n}_{3} = 0}^{{N}_{3} - 1} {x}_{{N}_{1} {N}_{2} {n}_{3} + {N}_{1} {n}_{2} + {n}_{1}} {{ω}^{{N}_{1} {N}_{2} {n}_{3}} ( {ω}^{2 {k}_{3}} )}^{{N}_{1} {N}_{2} {n}_{3}} ) \\ {( {ω}^{2 {k}_{3} + 1} )}^{{N}_{1} {n}_{2} + {n}_{1}} {( {ω}^{2 {k}_{2}} )}^{{N}_{3} {N}_{1} {n}_{2}}\end{matrix} ) ) {( {ω}^{2 {N}_{3} {k}_{2}} )}^{{N}_{1} {n}_{2} + {n}_{1}} {( {ω}^{2 {k}_{1}} )}^{{N}_{3} {N}_{2} {n}_{1}} \qquad ( 4 )$$

where X_{N}_{₃}_{N}_{₂}ₖ_{₁}_{+N}_{₃}ₖ_{₂}₊ₖ_{₃} is the output factor of (N₃N₂k₁+N₃k₂+k₃)-th multi-dimensional fast number theoretic transform, x_{N}_{₁}_{N}_{₂}ₙ_{₃}_{+N}_{₁}ₙ_{₂}₊ₙ_{₁} is the (N₁N₂n₃+N₁n₂+n₁)-th input matrix, ω is the twiddle factor, N₁*N₂*N₃ is N and N is the degree of the polynomial.

Equation (4) may be allocated to the computing circuits 13 for implementation. The computing circuits 13 include one or more first twiddle circuits, one or more second twiddle circuits, one or more stage conversion circuits, one or more transposition circuits, and one or more memory transposition circuits. Taking FIG. 7 as an example, the computing circuits 13 with such an architecture include two first twiddle circuits 13₂-1 and 13₂-13, two second twiddle circuits 13₂-2 and 13₂-12, three stage conversion circuits 13₂-3, 13₂-7, and 13₂-11, four transposition circuits 13₂-4, 13₂-6, 13₂-8, and 13₂-10, and two memory transposition circuits 13₂-5 and 13₂-9. The order of execution of the computing circuits 13 is the first twiddle circuit 13₂-1, the second twiddle circuit 13₂-2, the stage conversion circuit 13₂-3, the transposition circuit 13₂-4, the memory transposition circuit 13₂-5, the transposition circuit 13₂-6, the stage conversion circuit 13₂-7, the transposition circuit 13₂-8, the memory transposition circuit 13₂-9, the transposition circuit 13₂-10, the stage conversion circuit 13₂-11, the second twiddle circuit 13₂-12, and the first twiddle circuit 13₂-13.

In an embodiment, the sub-computations of the first twiddle circuits 13₂-1 and 13₂-13 are the multiplication computations of the twiddle factors, and reference may be made to the description of FIG. 4B.

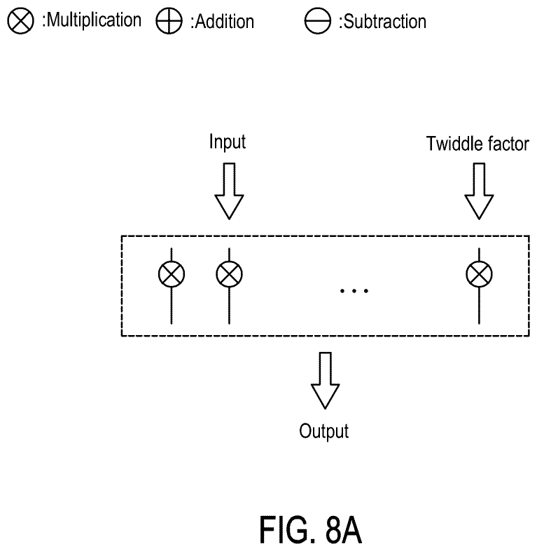

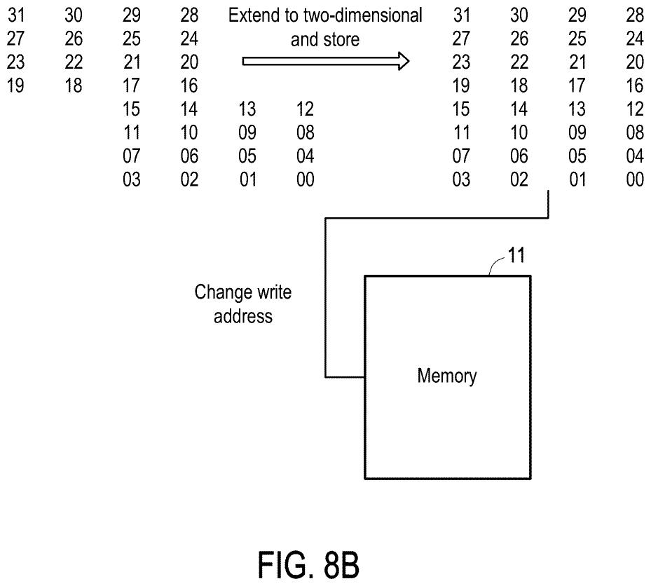

In an embodiment, the sub-computations of the second twiddle circuits 13₂-2 and 13₂-12 are the multiplication computation of the twiddle factors. FIG. 8A is a schematic diagram illustrating a multiplication computation with a twiddle factor according to an embodiment of the disclosure. Please refer to FIG. 8A. The output of the previous stage is used as the input, and the input is multiplied by the twiddle factor to obtain the output.

In an embodiment, the sub-computations of the stage conversion circuits 13₂-3, 13₂-7, and 13₂-11 are the butterfly computations, and reference may be made to the description of FIG. 4A.

In an embodiment, the sub-computations of the transposition circuits 13₂-4, 13₂-6, 13₂-8, and 13₂-10 are factor position swapping, and reference may be made to the description of FIG. 4C.

In an embodiment, the sub-computations of the memory transposition circuits 13₂-5 and 13₂-9 are memory address change. FIG. 8B is a schematic diagram illustrating memory address change according to an embodiment of the disclosure. Please refer to FIG. 8B. Two 4×4 matrices (for example

$$[ \begin{matrix}31 & 30 & 29 & 28 \\ 27 & 26 & 25 & 24 \\ 23 & 22 & 21 & 20 \\ 19 & 18 & 17 & 16\end{matrix} ] and [ \begin{matrix}15 & 14 & 13 & 12 \\ 11 & 10 & 09 & 08 \\ 07 & 06 & 05 & 04 \\ 03 & 02 & 01 & 00\end{matrix} ] )$$

on the left side of the drawing are extended and combined into a 8×4 matrix on the right side of the drawing. Next, a write address of each element in the 8×4 matrix in the memory 11 is changed. For example, each column in the matrix is converted to binary form. Taking the 8×4 matrix as an example, elements in each column are converted into three bits: abc are converted into bca (001->010).

Please refer to FIG. 7. The data conversion circuit 12 converts the input data into the input matrix according to the target dimension. The input data is the factors of the polynomial and is in vector form. The input data is, for example, data related to fully homomorphic encrypted ciphertext or plaintext. In addition, the target dimension is greater than one dimension (three dimensions in the embodiment). Therefore, the data conversion circuit 12 vectorizes the factors of the polynomial into the input data, and converts the input data into the two-dimensional input matrix. The column number or the row number of the input matrix is

$$\sqrt[d]{N} ,$$

such as

$$\sqrt[3]{N} .$$

In response to the target dimension being three-dimensional, the mathematical expression of multi-dimensional fast number theoretic transform is determined as Equation (4). Then, the multiplication computation is performed on the input matrix and the corresponding twiddle factor through the first twiddle circuit 13₂-1, the multiplication computation is performed on the output factor of the multiplication computation and the corresponding twiddle factor through the second twiddle circuit 13₂-2, the butterfly computation is performed on the output factor of the multiplication computation through the stage conversion circuit 13₂-3 of log ³\sqrt{N} sub-stages, factor position swapping is performed on the output factor of the butterfly computation through the transposition circuit 13₂-4, memory address change is performed on the position-swapped factor through the memory transposition circuit 13₂-5, factor position swapping is performed on the address-changed factor through the transposition circuit 13₂-6, the butterfly computation is performed on the position-swapped factor through the stage conversion circuit 13₂-7 of log ³\sqrt{N} sub-stages, factor position swapping is performed on the output factor of the butterfly computation through the transposition circuit 13₂-8, memory address change is performed on the position-swapped factor through the memory transposition circuit 13₂-9, factor position swapping is performed on the address-changed factor through the transposition circuit 13₂-10, the butterfly computation is performed on the position-swapped factor through the stage conversion circuit 13₂-11 of log ^{d}\textcircled{N} sub-stages (d is 3), the multiplication computation is performed on the output factor of the butterfly computation and the corresponding twiddle factor through the second twiddle circuit 13₂-12, and the multiplication computation is performed on the output factor of the multiplication computation and the corresponding twiddle factor through the first twiddle circuit 13₂-13. That is, three-dimensional multi-dimensional fast number theoretic transform is performed on the input matrix through the computing circuits 13 (that is, the two first twiddle circuits 13₂-1 and 13₂-13, the two second twiddle circuits 13₂-2 and 13₂-12, the four transposition circuits 13₂-4, 13₂-6, 13₂-8, and 13₂-10, and the two memory transposition circuits 13₂-5 and 13₂-9).

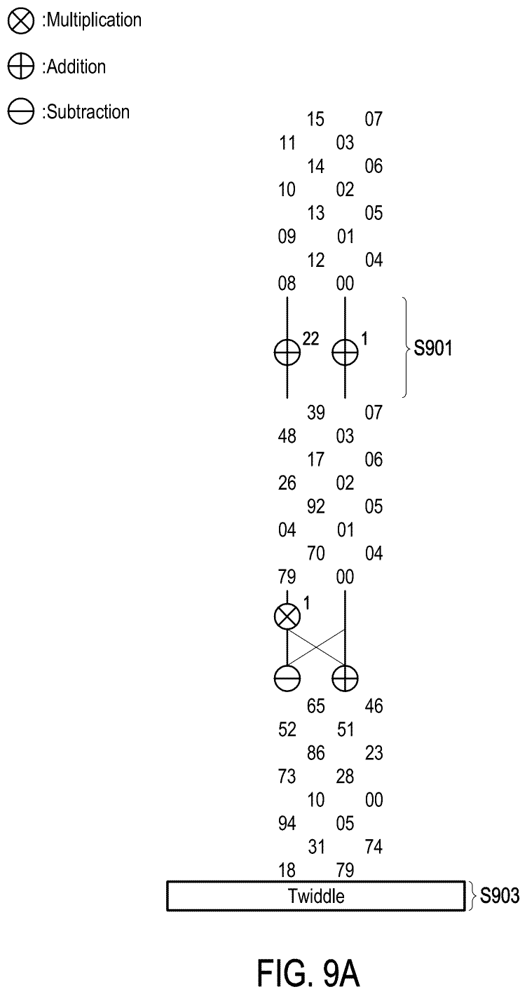

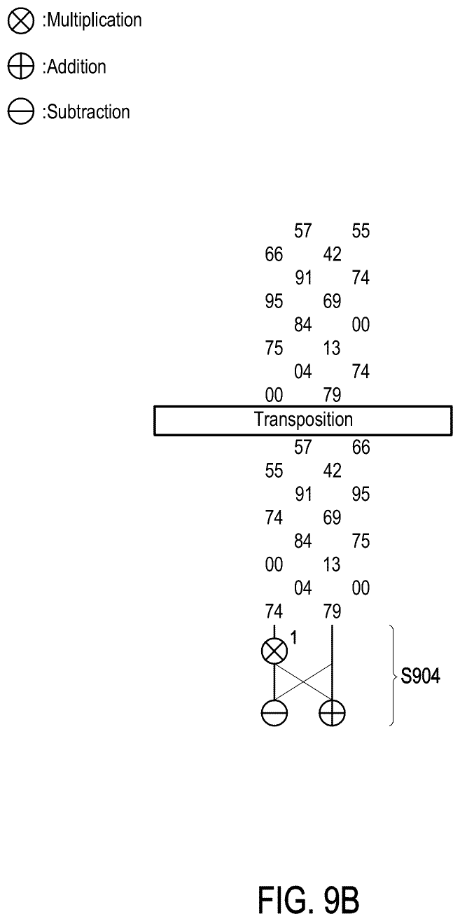

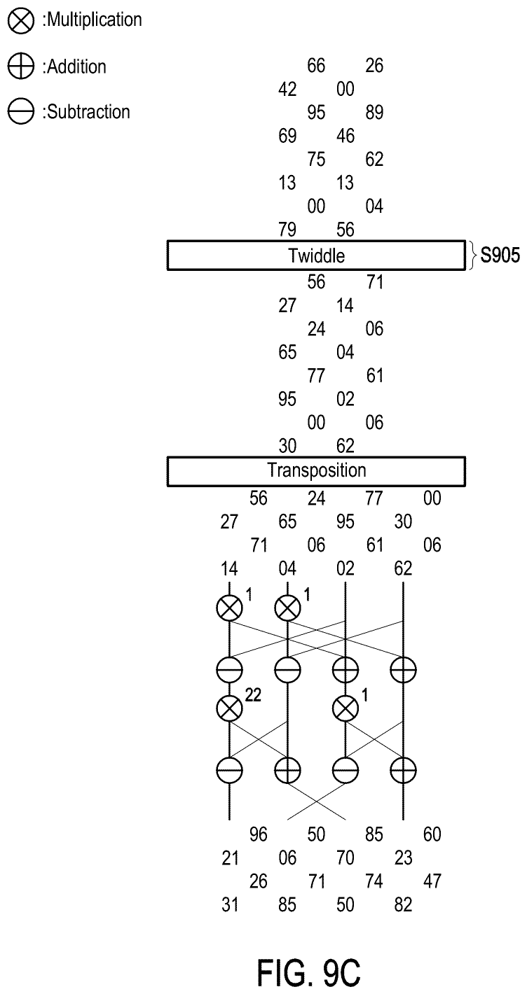

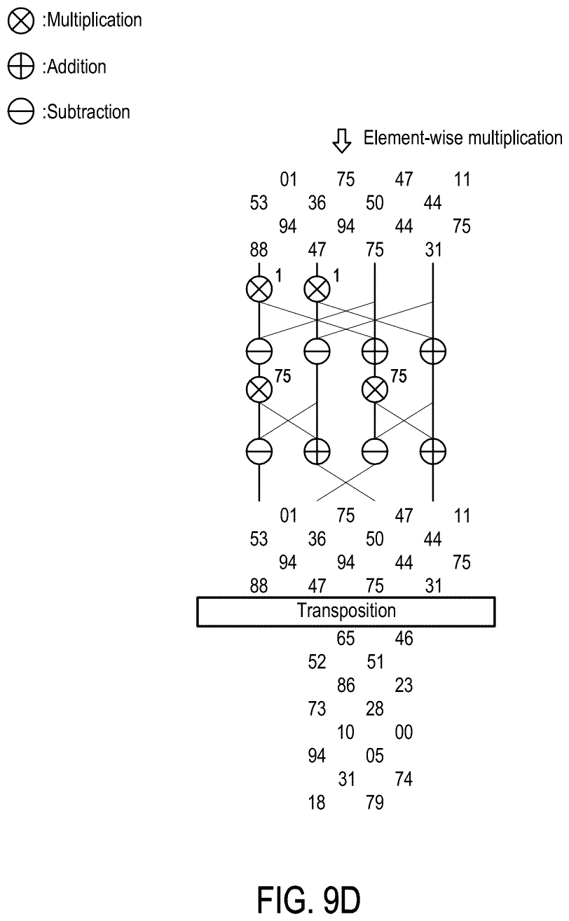

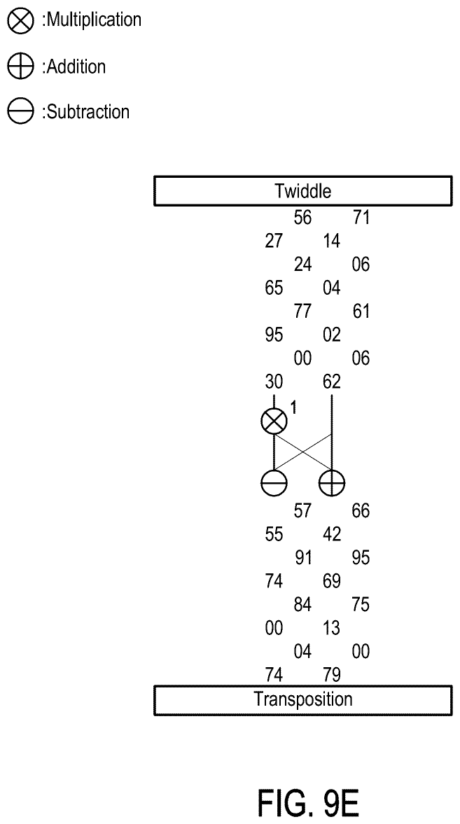

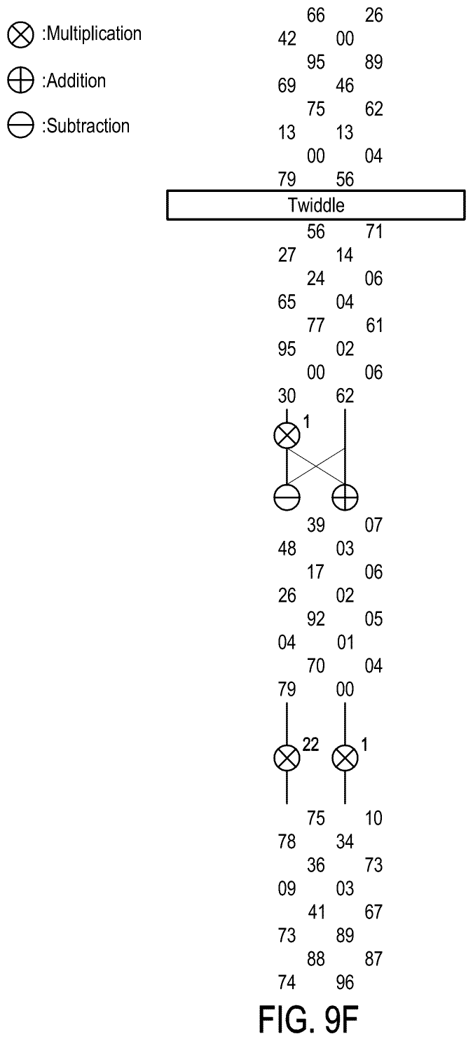

FIG. 9A to FIG. 9F are schematic diagrams illustrating three-dimensional fast number theoretic transform according to an embodiment of the disclosure. Please refer to FIG. 9A to FIG. 9F. ω^{N}^{₁}^{N}^{₂}ⁿ^{₃}, (ω^{2k}^{₃})^{N}^{₁}^{N}^{₂}ⁿ^{₃}, (ω^{2k}^{₃}⁺¹)^{N}^{₁}ⁿ^{₂}⁺ⁿ^{₁}, (ω^{2k}^{₂})^{N}^{₃}^{N}^{₁}ⁿ^{₂}, (ω^{2N}^{₃}^{k}^{₂})^{N}^{₁}ⁿ^{₂}⁺ⁿ^{₁}, and (ω^{2k}^{₁})^{N}^{₃}^{N}^{₂}ⁿ^{₁} are the twiddle factors used in the multiplication computations. The data conversion circuit converts 1×16 input data into two 4×2 input matrices, such as

$$[ \begin{matrix}11 & 03 \\ 10 & 02 \\ 09 & 01 \\ 08 & 00\end{matrix} ] and [ \begin{matrix}15 & 07 \\ 14 & 06 \\ 13 & 05 \\ 12 & 04\end{matrix} ] .$$

That is, one dimension is added to store or compute another two-dimensional matrix. In Step S901, the multiplication computation is performed on the twiddle factor ω^{N}^{₂}^{N}^{₂}ⁿ^{₃} is multiplied, such as

$$[ \begin{matrix}11 & 03 \\ 10 & 02 \\ 09 & 01 \\ 08 & 00\end{matrix} ] \times [ \begin{matrix}22 \\ 1\end{matrix} ] .$$

In Step S902, the multiplication computation is performed on the twiddle factor (ω^{2k}^{₃})^{N}^{₁}^{N}^{₂}ⁿ^{₃}. In Step S903, the multiplication computation is performed on the twiddle factor (ω^{2k}^{₃}⁺¹)^{N}^{₁}ⁿ^{₂}⁺ⁿ^{₁}. In Step S904, the multiplication computation is performed on the twiddle factor (ω^{2k}^{₂})^{N}^{₃}^{N}^{₁}ⁿ^{₂}. In Step S905, the multiplication computation is performed on the twiddle factor (ω^{2N}^{₃}^{k}^{₂})^{N}^{₁}ⁿ^{₂}⁺ⁿ^{₁}. In Step S906, the multiplication computation is performed on the twiddle factor (ω^{2k}^{₁})^{N}^{₃}^{N}^{₂}ⁿ^{₁}. The “twiddle” processing in the drawings is, for example, the sub-computation shown in FIG. 4B, that is, the multiplication computation is performed on the corresponding twiddle factor. In addition, the “transposition” processing in the drawings is, for example, the sub-computation shown in FIG. 4C, that is, factor position swapping. Finally, the output matrices

$$[ \begin{matrix}78 & 34 \\ 09 & 03 \\ 73 & 89 \\ 74 & 96\end{matrix} ] and [ \begin{matrix}75 & 10 \\ 36 & 73 \\ 41 & 67 \\ 88 & 87\end{matrix} ] ,$$

and the values are the same as the values in the output vector of FIG. 5C and the output matrix of FIG. 6D (the difference is only in the positions of the matrix).

In an embodiment, the twiddle factors may be prestored in the memory 11 for subsequent computations. In another embodiment, some or all of the twiddle factors may be generated on the fly or dynamically. For example, the generated twiddle factors may be computed on the fly using the multiplication factor and the starting twiddle factor. At this time, the amount of data required to be stored is O(n\hat{ }(½)).

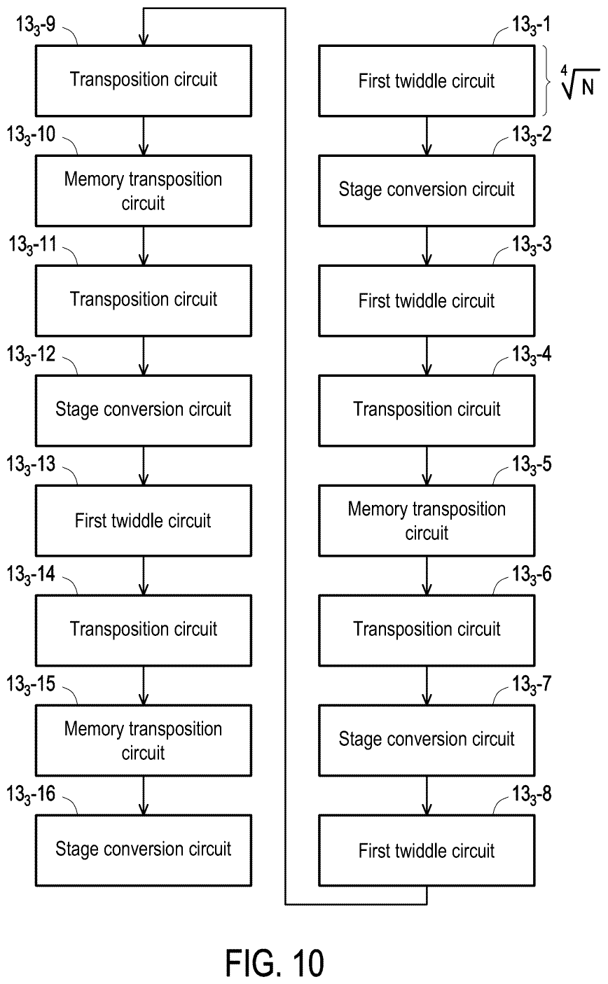

FIG. 10 is a system architecture diagram of four-dimensional fast number theoretic transform according to an embodiment of the disclosure. Please refer to FIG. 10, which shows a four-dimensional pipelined multi-dimensional fast number theoretic transform architecture. For a four-dimensional computation (d of Equation (2) is 4), the mathematical expression of multi-dimensional fast number theoretic transform is:

$${X}_{{N}_{4} {N}_{3} {N}_{2} {k}_{1} + {N}_{4} {N}_{3} {k}_{2} + {N}_{4} {k}_{3} + {k}_{4}} = {\sum }_{{n}_{1} = 0}^{{N}_{1} - 1} {\sum }_{{n}_{2} = 0}^{{N}_{2} - 1} {\sum }_{{n}_{3} = 0}^{{N}_{3} - 1} {\sum }_{{n}_{4} = 0}^{{N}_{4} - 1} {x}_{{N}_{1} {N}_{2} {N}_{3} {n}_{4} + {N}_{1} {N}_{2} {n}_{3} + {N}_{1} {n}_{2} + {n}_{1}} {( {ω}^{2 ( {N}_{4} {N}_{3} {N}_{2} {k}_{1} + {N}_{4} {N}_{3} {k}_{2} + {N}_{4} {k}_{3} + {k}_{4} ) + 1} )}^{{N}_{1} {N}_{2} {N}_{3} {n}_{4} + {N}_{1} {N}_{2} {n}_{3} + {N}_{1} {n}_{2} + {n}_{1}} = {\sum }_{{n}_{2} = 0}^{{N}_{2} - 1} ( {\sum }_{{n}_{3} = 0}^{{N}_{3} - 1} ( \begin{matrix}( {\sum }_{{n}_{4} = 0}^{{N}_{4} - 1} {x}_{{N}_{4} {N}_{3} {N}_{2} {k}_{1} + {N}_{4} {N}_{3} {k}_{2} + {N}_{4} {k}_{3} + {k}_{4}} {{ω}^{{N}_{1} {N}_{2} {N}_{3} {n}_{4}} ( {ω}^{2 {k}_{4}} )}^{{N}_{1} {N}_{2} {N}_{3} {n}_{4}} ) \\ {( {ω}^{2 {k}_{4} + 1} )}^{{N}_{1} {N}_{2} {n}_{3} + {N}_{1} {n}_{2} + {n}_{1}} {( {ω}^{2 {k}_{3}} )}^{{N}_{4} {N}_{2} {N}_{1} {n}_{3}}\end{matrix} ) ) {( {ω}^{2 {N}_{4} {k}_{3}} )}^{{N}_{1} {N}_{2} {n}_{3} + {N}_{1} {n}_{2} + {n}_{1}} {( {ω}^{2 {k}_{2}} )}^{{N}_{4} {N}_{3} {N}_{1} {n}_{3}} {( {ω}^{2 {N}_{4} {N}_{3} {k}_{2}} )}^{{N}_{1} {n}_{2} + {n}_{1}} {( {ω}^{2 {k}_{1}} )}^{{N}_{4} {N}_{3} {N}_{2} {n}_{1}} \qquad ( 5 )$$

where X_{N}_{₄}_{N}_{₃}_{N}_{₂}ₖ_{₁}_{+N}_{₄}_{N}_{₃}ₖ_{₂}_{+N}_{₄}ₖ_{₃}₊ₖ_{₄} is the output factor of (N₄N₃N₂k₁+N₄N₃k₂+N₄k₃+k₄)-th multi-dimensional fast number theoretic transform, x_{N}_{₄}_{N}_{₃}_{N}_{₂}ₖ_{₁}_{+N}_{₄}_{N}_{₃}ₖ_{₂}_{+N}_{₄}ₖ_{₃}₊ₖ_{₄} is the (N₄N₃N₂k₁+N₄N₃k₂+N₄k₃+k₄)-th input matrix, ω is the twiddle factor, N₁·N₂·N₃·N₄ is N⁴, and N is the degree of the polynomial.

Equation (5) may be allocated to the computing circuits 13 for implementation. The computing circuits 13 include one or more first twiddle circuits, one or more stage conversion circuits, one or more transposition circuits, and one or more memory transposition circuits. Taking FIG. 10 as an example, the computing circuits 13 with such an architecture include four first twiddle circuits 13₃-1, 13₃-3, 13₃-8, and 13₃-13, four stage conversion circuits 13₃-2, 13₃-7, 13₃-12, and 13₃-16, five transposition circuits 13₃-4, 13₃-6, 13₃-9, 13₃-11, and 13₃-14, and three memory transposition circuits 13₃-5, 13₃-10, and 13₃-15. The order of execution of the computing circuits 13 is the first twiddle circuit 13₃-1, the stage conversion circuit 13₃-2, the first twiddle circuit 13₃-3, the transposition circuit 13₃-4, the memory transposition circuit 13₃-5, the transposition circuit 13₃-6, the stage conversion circuit 13₃-7, the first twiddle circuit 13₃-8, the transposition circuit 13₃-9, the memory transposition circuit 13₃-10, the transposition circuit 13₃-11, the stage conversion circuit 13₃-12, the first twiddle circuit 13₃-13, the transposition circuit 13₃-14, the memory transposition circuit 13₃-15, and the stage conversion circuit 13₃-16.

In an embodiment, the sub-computations of the first twiddle circuits 13₃-1, 13₃-3, 13₃-8, and 13₃-13 are the multiplication computations of the twiddle factors, and reference may be made to the description of FIG. 4B.

In an embodiment, the sub-computations of the stage conversion circuits 13₃-2, 13₃-7, 13₃-12, and 13₃-16 are the butterfly computations, and reference may be made to the description of FIG. 4A.

In an embodiment, the sub-computations of the transposition circuits 13₃-4, 13₃-6, 13₃-9, 13₃-11, and 13₃-14 are factor position swapping, and reference may be made to the description of FIG. 4C.

In an embodiment, the sub-computations of the memory transposition circuits 13₃-5, 13₃-10, and 13₃-15 are memory address change, and reference may be made to the description of FIG. 8B.

Please refer to FIG. 10. The data conversion circuit 12 converts the input data into the input matrix according to the target dimension. The input data is the factors of the polynomial and is in vector form. The input data is, for example, data related to fully homomorphic encrypted ciphertext or plaintext. In addition, the target dimension is greater than one dimension (four dimensions in the embodiment). Therefore, the data conversion circuit 12 vectorizes the factors of the polynomial into the input data, and converts the input data into the two-dimensional input matrix. The column number or the row number of the input matrix is ^{d}\sqrt{N}, such as ^{d}\sqrt{N}.

In response to the target dimension being four-dimensional, the mathematical expression of multi-dimensional fast number theoretic transform is determined as Equation (5). Then, the multiplication computation is performed on the input matrix and the corresponding twiddle factor through the first twiddle circuit 13₃-1, the butterfly computation is performed on the output factor of the multiplication computation through the stage conversion circuit 13₃-2 of log ^{d}\sqrt{N} sub-stages (d is 4), the multiplication computation is performed on the output factor of the butterfly computation and the corresponding twiddle factor through the first twiddle circuit 13₃-3, factor position swapping is performed on the output factor of the multiplication computation through the transposition circuit 13₃-4, memory address change is performed on the position-swapped factor through the memory transposition circuit 13₃-5, memory address change is performed on the position-swapped factor through the transposition circuit 13₃-6, the butterfly computation is performed on the address-changed factor through the stage conversion circuit 13₃-7 of log ⁴\sqrt{N} sub-stages, the multiplication computation with the corresponding twiddle factor is performed through the first twiddle circuit 13₃-8, factor position swapping is performed on the output factor of the multiplication computation through the transposition circuit 13₃-9, memory address change is performed on the position-swapped factor through the memory transposition circuit 13₃-10, factor position swapping is performed on the address-changed factor through the transposition circuit 13₃-11, the butterfly computation is performed on the position-swapped factor through the stage conversion circuit 13₃-12 of log ⁴\sqrt{N} sub-stages, the multiplication computation is performed on the output factor of the butterfly computation and the corresponding twiddle factor through the first twiddle circuit 13₃-13, factor position swapping is performed on the output factor of the multiplication computation through the transposition circuit 13₃-14, memory address change is performed on the position-swapped factor through the memory transposition circuit 13₃-15, and the butterfly computation is performed on the address-changed factor through the stage conversion circuit 13₃-16 of log ⁴\sqrt{N} sub-stages.

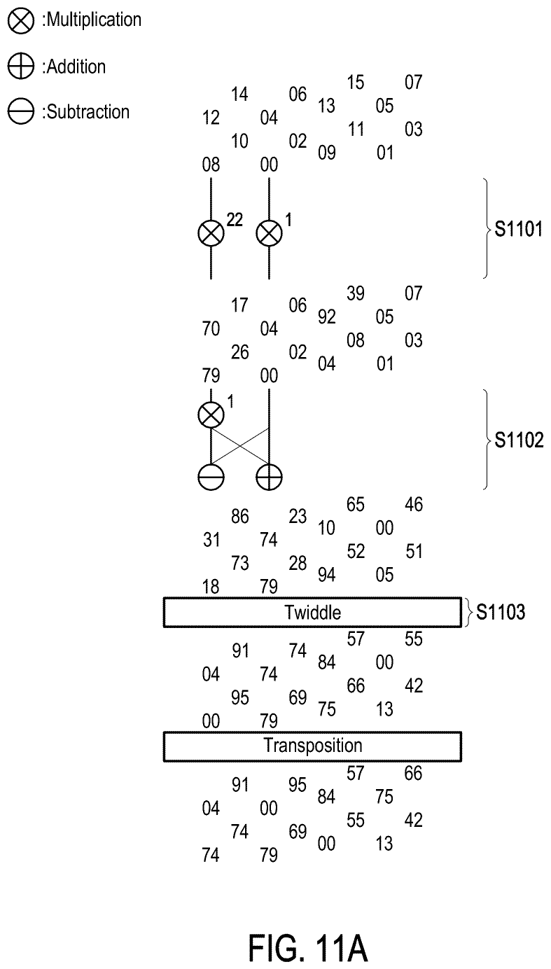

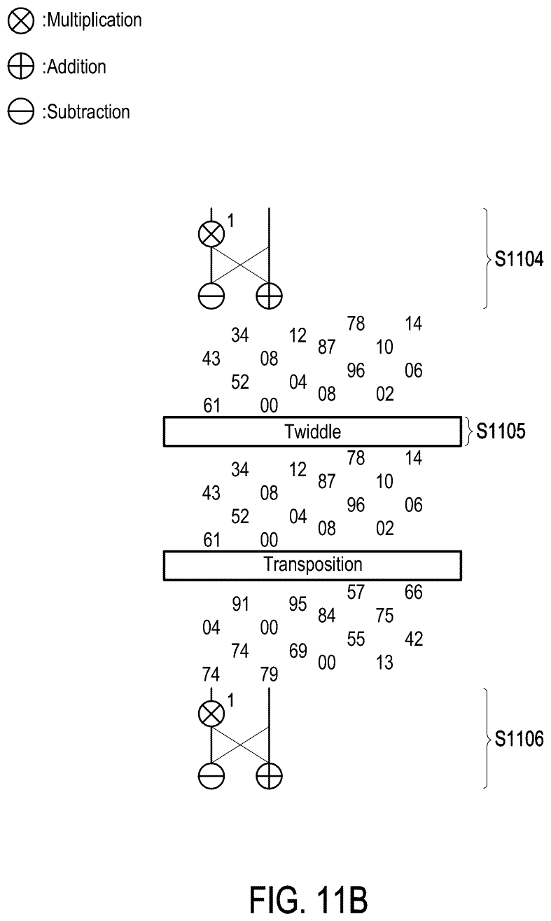

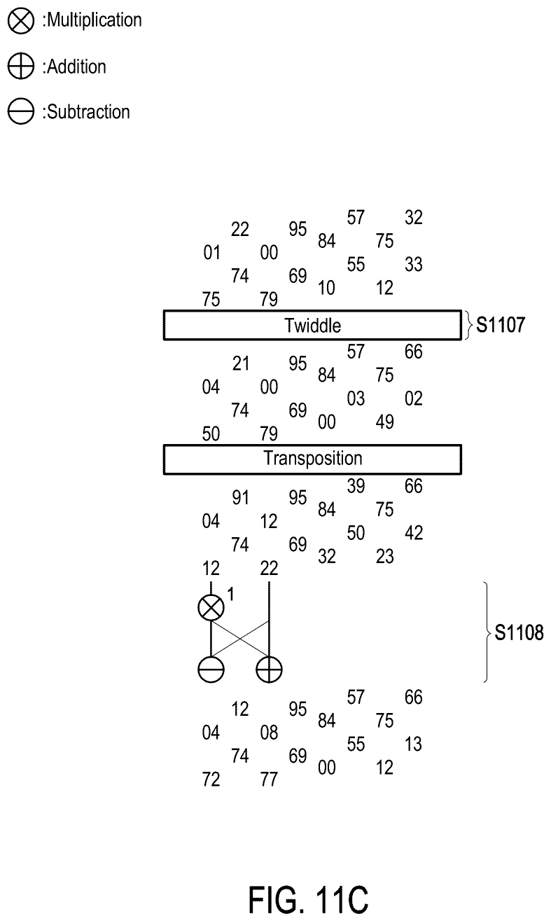

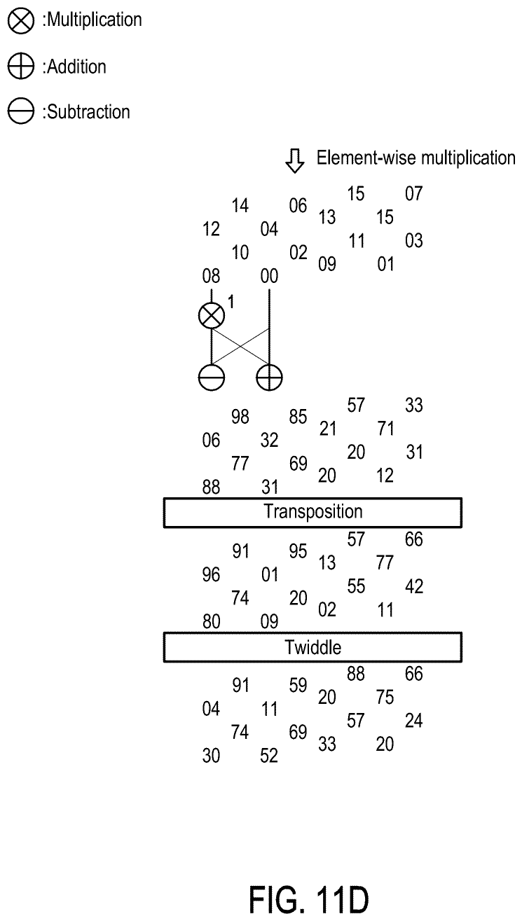

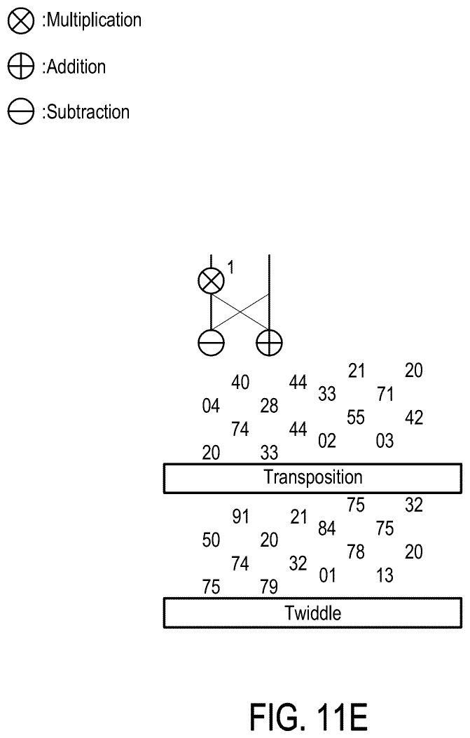

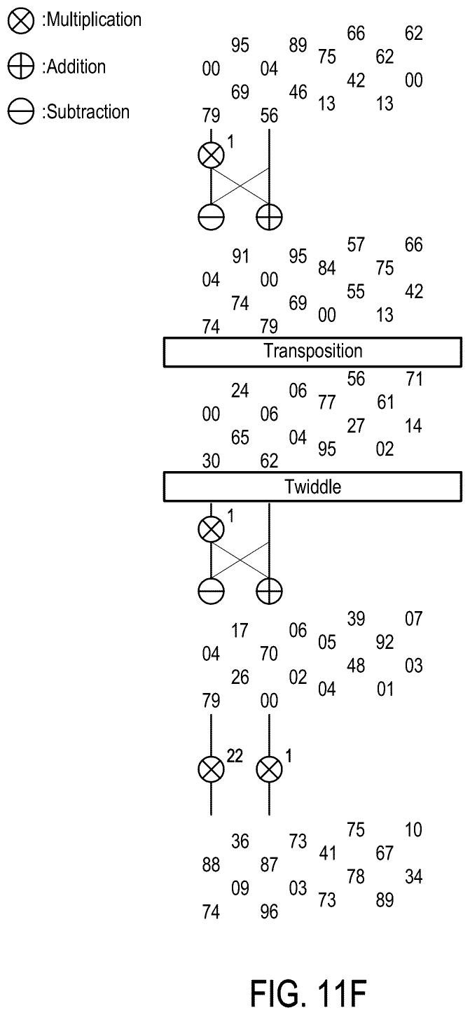

FIG. 11A to FIG. 11F are schematic diagrams illustrating four-dimensional fast number theoretic transform according to an embodiment of the disclosure. Please refer to FIG. 11A to FIG. 11F. ω^{N}^{₁}^{N}^{₂}^{N}^{₃}ⁿ^{₄}, (ω^{2k}^{₄})^{N}^{₁}^{N}^{₂}^{N}^{₃}ⁿ^{₄}, (ω^{2k}^{₄}⁺¹)^{N}^{₁}^{N}^{₂}ⁿ^{₃}^{+N}^{₁}ⁿ^{₂}⁺ⁿ^{₁}, (ω^{2k}^{₃})^{N}^{₄}^{N}^{₂}^{N}^{₁}ⁿ^{₃}, (ω^{2N}^{₄}^{k}^{₃})^{N}^{₁}^{N}^{₂}ⁿ^{₃}^{+N}^{₁}ⁿ^{₂}⁺ⁿ^{₁}, (ω^{2k}^{₂})^{N}^{₄}^{N}^{₃}^{N}^{₁}ⁿ^{₃}, (ω^{2N}^{₄}^{N}^{₃}^{k}^{₂})^{N}^{₁}ⁿ^{₂}⁺ⁿ^{₁}, and (ω^{2k}^{₁})^{N}^{₄}^{N}^{₃}^{N}^{₂}ⁿ^{₁} are the twiddle factors used in the multiplication computations. The data conversion circuit converts 1×16 input data into four 2×2 input matrices, such as

$$[ \begin{matrix}12 & 04 \\ 08 & 00\end{matrix} ] , [ \begin{matrix}13 & 05 \\ 09 & 01\end{matrix} ] , [ \begin{matrix}14 & 06 \\ 10 & 02\end{matrix} ] , and [ \begin{matrix}15 & 07 \\ 11 & 03\end{matrix} ] .$$

That is, two dimensions are added to store or compute another two two-dimensional matrices. In Step S1101, the multiplication computation is performed on the twiddle factor ω^{N}^{₁}^{N}^{₂}ⁿ^{₃}ⁿ^{₄}, such as

$$[ \begin{matrix}12 & 04 \\ 08 & 00\end{matrix} ] \times [ \begin{matrix}22 \\ 1\end{matrix} ] .$$

In Step S1102, the multiplication computation is performed on the twiddle factor (ω^{2k}^{₄})^{N}^{₁}^{N}^{₂}^{N}^{₃}ⁿ^{₄}. In Step S1103, the multiplication computation is performed on the twiddle factor (ω^{2k}^{₄}⁺¹)^{N}^{₁}^{N}^{₂}ⁿ^{₃}^{+N}^{₁}ⁿ^{₂}⁺ⁿ^{₁}. In Step S1104, the multiplication computation is performed on the twiddle factor (ω^{2k}^{₃})^{N}^{₄}^{N}^{₂}^{N}^{₁}ⁿ^{₃}. In Step S1105, the multiplication computation is performed on the twiddle factor (ω^{2N}^{₄}^{k}^{₃})^{N}^{₁}^{N}^{₂}ⁿ^{₃}^{+N}^{₁}ⁿ^{₂}⁺ⁿ^{₁}. In Step S1106, the multiplication computation is performed on the twiddle factor (ω^{2k}^{₂})^{N}^{₄}^{N}^{₃}^{N}^{₁}ⁿ^{₃}. In Step S1107, the multiplication computation is performed on the twiddle factor (ω^{2N}^{₄}^{N}^{₃}^{k}^{₂})^{N}^{₁}ⁿ^{₂}⁺ⁿ^{₁}. In Step S1108, the multiplication computation is performed on the twiddle factor (ω^{2k}^{₁})^{N}^{₄}^{N}^{₃}^{N}^{₂}ⁿ^{₁}. The “twiddle” processing in the drawings is, for example, the sub-computation shown in FIG. 4B, that is, the multiplication computation is performed on the corresponding twiddle factor. In addition, the “transposition” processing in the drawings is, for example, the sub-computation shown in FIG. 4C, that is, factor position swapping. Finally, the output matrix is

$$[ \begin{matrix}88 & 87 \\ 74 & 96\end{matrix} ] , [ \begin{matrix}41 & 67 \\ 73 & 89\end{matrix} ] , [ \begin{matrix}36 & 73 \\ 09 & 03\end{matrix} ] , and [ \begin{matrix}75 & 10 \\ 78 & 34\end{matrix} ] ,$$

and the values are the same as the values in the output vector of FIG. 5C and the output matrices of FIG. 6D and FIG. 9F (the difference is only in the positions of the matrix).

In an embodiment, the twiddle factors may be prestored in the memory 11 for subsequent computations. In another embodiment, some or all of the twiddle factors may be generated on the fly or dynamically. For example, the resulting twiddle factor may be computed on the fly using the multiplication factor and the starting twiddle factor. At this time, the amount of data required to be stored is O(n\hat{ }(⅓)).

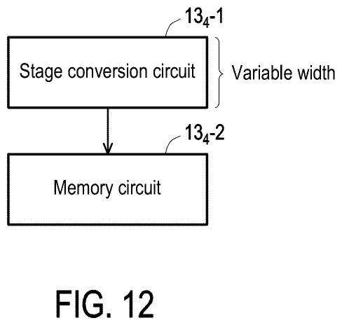

FIG. 12 is a system architecture diagram of non-pipelined fast number theoretic transform according to an embodiment of the disclosure. Please refer to FIG. 12, which shows a non-pipelined fast number theoretic transform architecture. Such an architecture may be implemented through the computing circuits 13. The computing circuits 13 include one or more stage conversion circuits and one or more memory circuits. Taking FIG. 12 as an example, the computing circuits 13 with such an architecture include a stage conversion circuit 13₄-1 and a memory circuit 13₄-2. The order of execution of the computing circuits 13 is the stage conversion circuit 13₄-1 and the memory circuit 13₄-2.

In an embodiment, the sub-computation of the stage conversion circuit 13₄-1 is the butterfly computation, and reference may be made to the description of FIG. 4A.

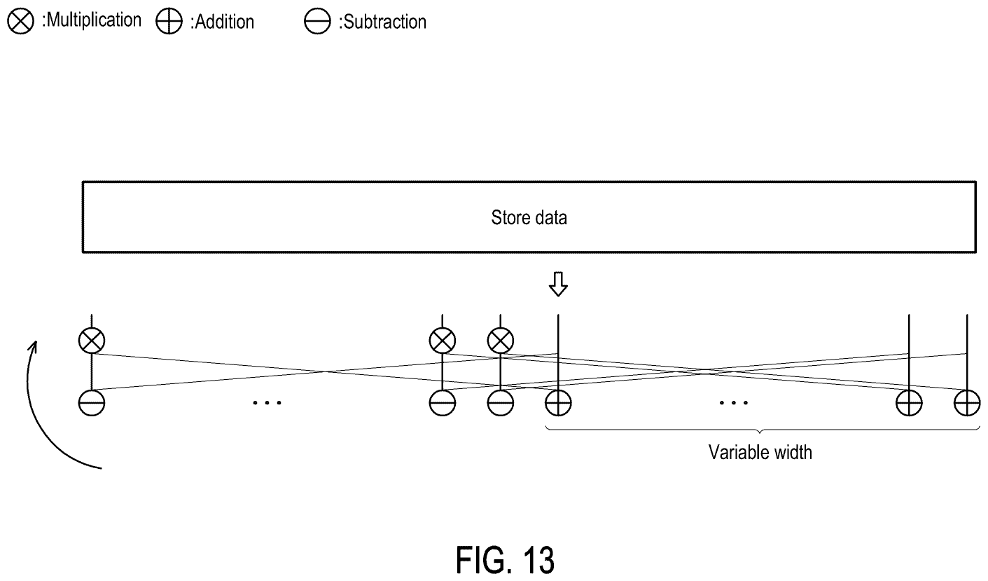

In an embodiment, the sub-computation of the memory circuit 13₄-2 is to store data to one or more memories 11. FIG. 13 is a schematic diagram illustrating data storage according to an embodiment of the disclosure. Please refer to FIG. 13. Data is accessed from the memory 11, the butterfly computation is performed on the accessed data, and a result of the butterfly computation is stored in the memory 11. It should be noted that the width in the butterfly computation may be changed according to actual requirements.

Please refer to FIG. 12. The data conversion circuit 12 converts the input data into the input matrix according to the target dimension. The input data is the factors of the polynomial and is in vector form. The input data is, for example, data related to fully homomorphic encrypted ciphertext or plaintext. In addition, the target dimension is greater than one dimension (two dimensions in the embodiment). Therefore, the data conversion circuit 12 vectorizes the factors of the polynomial into the input data, and converts the input data into the two-dimensional input matrix. At this time, the column number or the row number of the input matrix may be adjusted according to actual requirements.

In response to a non-pipelined computation, the butterfly computation is performed through the stage conversion circuit 13₄-1 of one sub-stage, and the output factor of the butterfly computation is stored in the memory 11 through the memory circuit 13₄-2.

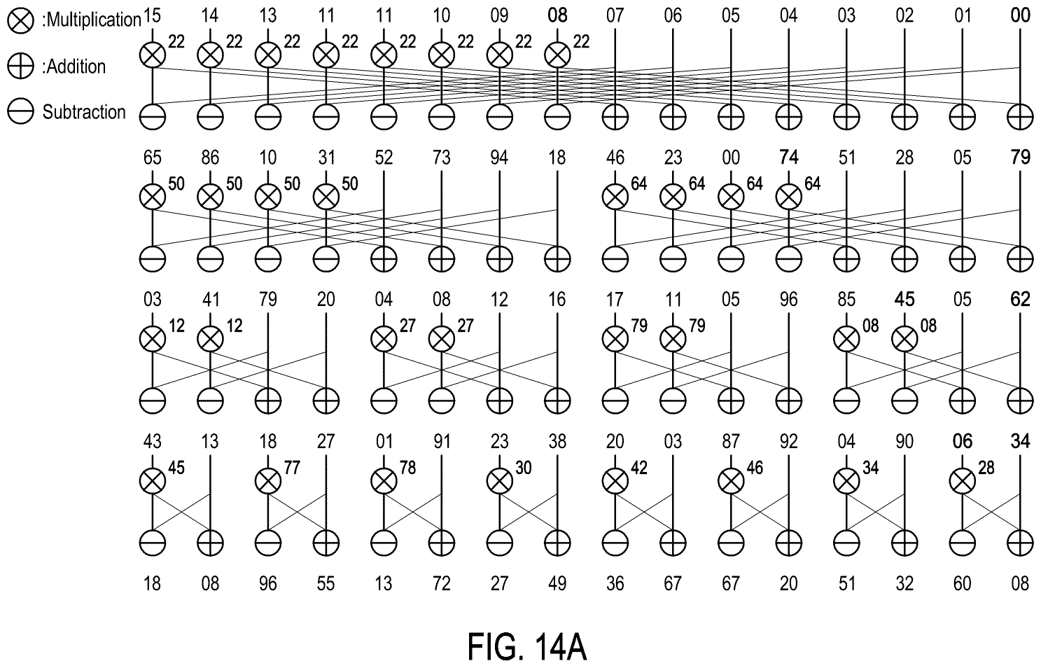

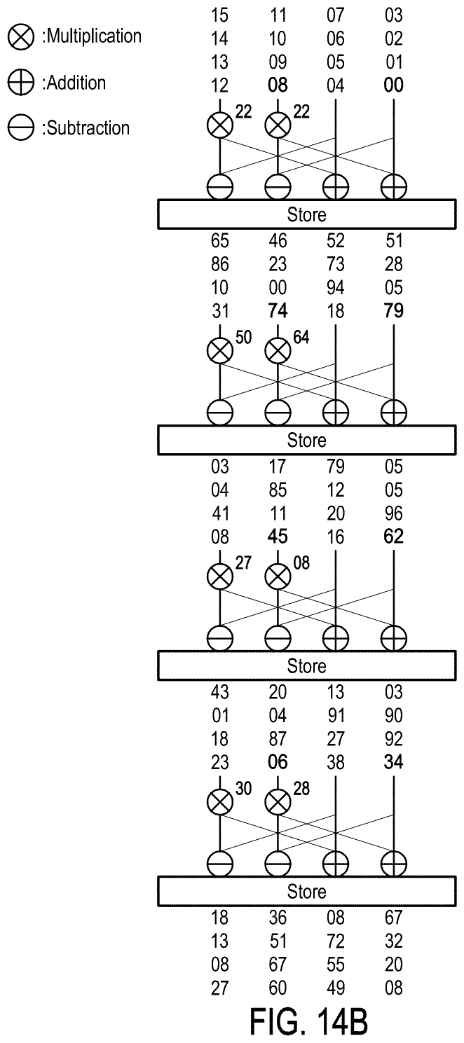

FIG. 14A is a schematic diagram illustrating forward fast number theoretic transform according to an embodiment of the disclosure, and FIG. 14B is a schematic diagram illustrating non-pipelined fast number theoretic transform according to an embodiment of the disclosure. Please refer to FIG. 14B. The data conversion circuit converts 1×16 input data into a 4×4 input matrix, such as

$$[ \begin{matrix}15 & 11 & 07 & 03 \\ 14 & 10 & 06 & 02 \\ 13 & 09 & 05 & 01 \\ 12 & 08 & 04 & 00\end{matrix} ] .$$

However, the column number or the row number of the input matrix may still be changed according to actual requirements. The “storage” processing in the drawings is, for example, the sub-computation shown in FIG. 13, that is, the butterfly computation is performed and a computation result is stored. The output matrix is

$$[ \begin{matrix}18 & 36 & 08 & 67 \\ 13 & 51 & 72 & 32 \\ 08 & 67 & 55 & 22 \\ 27 & 60 & 49 & 08\end{matrix} ]$$

(corresponding to a result of forward fast number theoretic transform shown in FIG. 14A, and the difference is only in the positions of the matrix).

In addition to two-dimensional, three-dimensional, and four-dimensional multi-dimensional fast number theoretic transform above, higher-dimensional multi-dimensional fast number theoretic transform may also be extended to based on Equation (2). In some application scenarios, higher-dimensional hardware architectures have deeper pipelined depths and longer computing delay, but smaller data throughput for the same number of times. However, higher-dimensional hardware architectures require fewer multipliers and require smaller amounts of data of twiddle factors to be stored. In other words, lower-dimensional hardware architectures have shallower pipelined depths and shorter computing delay, but greater data throughput for the same number of times. However, lower-dimensional hardware architectures require more multipliers and require greater amounts of data of twiddle factors to be stored.

For example, Table (1) shows the correspondence between the number of multipliers, the number of adders, the number of block memories, and the delay of the target dimension being respectively two-dimensional, three-dimensional, and four-dimensional under a condition that an experimental target is N=65536.

TABLE 1

| | Number of | Number of | Number of | |
|---|---|---|---|---|
| N = 65536 | multipliers | adders | block memories | Delay |
| Two-dimensional | 2560 | 4096 | 64 | 274 |
| (256 × 256) | | | | |
| Three-dimensional | 432 | 608 | 240 | 8337 |
| (32 × 32 × 65) | | | | |
| Four-dimensional | 256 | 256 | 168 | 12388 |
| (16 × 16 × 16 × 16) | | | | |

In terms of multiplier resource usage, the architecture of the target dimension being three-dimensional is 1.7 times the architecture of the target dimension being four-dimensional, but the delay is 0.67 times.

For another example, Table (2) shows the correspondence between the number of multipliers, the number of adders, the number of block memories, and the delay of the target dimension being respectively two-dimensional, three-dimensional, and four-dimensional under a condition that the experimental target is N=16384.

TABLE 2

| | Number of | Number of | Number of | |
|---|---|---|---|---|
| N = 16384 | multipliers | adders | block memories | Delay |
| Two-dimensional | 1152 | 1792 | 32 | 144 |
| (128 × 128) | | | | |
| Three-dimensional | 304 | 608 | 240 | 2193 |
| (32 × 32 × 32) | | | | |
| Four-dimensional | 256 | 256 | 168 | 3172 |
| (16 × 16 × 16 × 4) | | | | |

In terms of multiplier resource usage, the architecture of the target dimension being three-dimensional is 1.3 times the architecture of the target dimension being four-dimensional, but the delay is 0.69 times.

In an embodiment, the processing system 10 includes multiple first computing circuits and multiple second computing circuits. The first computing circuits include the computing circuits 13 for multi-dimensional fast number theoretic transform of a first dimension, the second computing circuits include the computing circuits 13 for multi-dimensional fast number theoretic transform of a second dimension, and the first dimension is different from the second dimension. For example, the first computing circuits include the two stage conversion circuits 13₁-1 and 13₁-4, the first twiddle circuit 13₁-2, and the transposition circuit 13₁-3 (that is, the first dimension is two-dimensional) shown in FIG. 3, and the second computing circuits include the two first twiddle circuits 13₂-1 and 13₂-13, the two second twiddle circuits 13₂-2 and 13₂-12, the three stage conversion circuits 13₂-3, 13₂-7, and 13₂-11, the four transposition circuits 13₂-4, 13₂-6, 13₂-8, and 13₂-10, and the two memory transposition circuits 13₂-5 and 13₂-9 (that is, the second dimension is three-dimensional) as shown in FIG. 7.

The data conversion circuit 12 may convert the input data into the input matrix that conforms to the first computing circuits or the second computing circuits according to the target dimension. For example, if the target dimension is two-dimensional, the input data is converted into the input matrix with the column number \sqrt{N}; and if the target dimension is four-dimensional, the input data is converted into the input matrix with the column number

$$\sqrt[d]{N}$$

(d is 4).

In an embodiment, the data conversion circuit 12 may select one of the first computing circuit and the second computing circuit to perform fast number theoretic transform according to requirements (for example, hardware limitations or delay limitations). For example, if the delay limitation is short, a set of the computing circuits 13 with a smaller target dimension is selected to perform fast number theoretic transform.

In some embodiments, the processing system 10 may include more computing circuits 13 corresponding to different dimensions. For example, the processing system 10 includes the computing circuits 13 corresponding to two dimensions, three dimensions, and four dimensions.

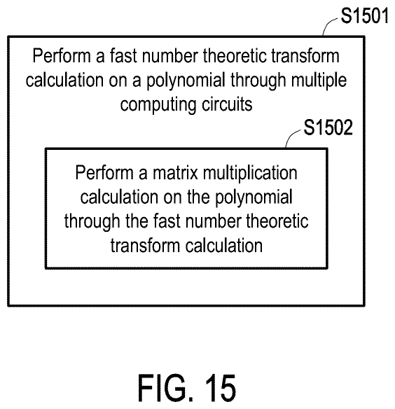

FIG. 15 is a flowchart of an encryption method according to an embodiment of the disclosure. Please refer to FIG. 15. The computing circuits 13 are used to perform the fast number theoretic transform calculation, such as two-dimensional fast number theoretic transform shown in FIG. 3, FIG. 4A to FIG. 4C, and FIG. 6A to FIG. 6D, one-dimensional fast number theoretic transform shown in FIG. 5A to FIG. 5C, three-dimensional fast number theoretic transform shown in FIG. 7, FIG. 8A to FIG. 8B, and FIG. 9A to FIG. 9F, four-dimensional fast number theoretic transform shown in FIG. 10 and FIG. 11A to FIG. 11F, or non-pipelined fast number theoretic transform shown in FIG. 12, FIG. 13, and FIG. 14A and FIG. 14B, on the polynomial (Step S1501). The computing circuits 13 perform the matrix multiplication calculation on the polynomial through the fast number theoretic transform calculation (Step S1502). In an embodiment, the elements of the input matrix are the factors of the polynomial used for encryption, such as the factors of the polynomial related to ciphertext or plaintext used for fully homomorphic encryption. In an embodiment, the elements of the input matrix are respectively the same as the elements in the input data (one-to-one element correspondence). The input data is also the factors of the same polynomial and is in vector form. In an embodiment, the fast number theoretic transform is calculated as multi-dimensional fast number theoretic transform of the target dimension. The target dimension may be determined. The target dimension is greater than one dimension. For example, the data conversion circuit 12 determines whether the target dimension is two-dimensional, three-dimensional, or four-dimensional. The input data is converted into the input matrix according to the target dimension. For example, in response to the target dimension being three-dimensional, the data conversion circuit 12 converts the vector input data into the two two-dimensional input matrices. Then, multi-dimensional fast number theoretic transform of the target dimension is performed on the input matrix through the computing circuits 13. Multi-dimensional fast number theoretic transform converts matrix-vector multiplication into a multi-stage computation architecture of the matrix multiplication calculation through multiple sub-computations, one computing circuit 13 performs one sub-computation, and each sub-computation is located at one stage of the multi-stage computation architecture.

The implementation details of each step in FIG. 15 have been described in detail in the foregoing embodiments and implementations, and will not be described again here.

In some application scenarios, in addition to a fully homomorphic encryption system, multi-dimensional fast number theoretic transform of the embodiments of the disclosure is also suitable for various lattice cryptography and various applications related to polynomial calculations.

In some application scenarios, a field programmable gate array (FPGAs) has powerful parallel computing ability and can handle encryption and computing requirements of multiple data blocks at the same time. Implementing the multi-stage hardware architecture of the embodiments of the disclosure through the FPGA may make full use of the parallel computing ability of the FPGA, thereby implementing high-efficiency data processing. However, according to different design requirements, the processing system 10 is not limited to the implementation form of the FPGA.

In some application scenarios, fully homomorphic encryption can ensure that data during a computation process remains encrypted, thereby ensuring the security of the data. The embodiments of the disclosure can strengthen the security protection and ensure that the data is not exposed to an unauthorized environment at any time.

In some application scenarios, in big data scenarios, the amount of data is huge and needs to be processed in a timely manner, which puts higher requirements on the traditional fully homomorphic encryption technology. The embodiments of the disclosure can provide the high-efficiency fast number theoretic transform computation and the parallel computing ability of the processing system 10, thereby meeting the processing requirements for large-scale data.

In some application scenarios, the multiplication computation related to the polynomial in fully homomorphic encryption may be implemented through the processing system 10 of the embodiments of the disclosure, such as an encryption and/or decryption computation on plaintext or ciphertext.

In summary, in the processing system and method related to encryption of the embodiments of the disclosure, the sub-computations in multi-dimensional fast number theoretic transform are respectively implemented through the corresponding computing circuits, and the pipelined and non-pipelined architectures are provided. In this way, the computing efficiency of fast number theoretic transform can be improved, and fully homomorphic encryption or other lattice-based encryption algorithms are also suitable.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A processing system related to encryption, comprising:
a plurality of computing circuits, performing a fast number theoretic transform (NTT) calculation on a polynomial, comprising:
performing a matrix multiplication calculation on the polynomial through the fast number theoretic transform calculation.

2. The processing system related to encryption according to claim 1, further comprising:
at least one memory, coupled to the computing circuits and configured to store data;
a data conversion circuit, coupled to the at least one memory and the computing circuits, and configured to convert input data into an input matrix according to a target dimension, wherein the input data is factors of the polynomial and is in vector form, the target dimension is greater than one dimension, the fast number theoretic transform calculation is multi-dimensional fast number theoretic transform, and
the computing circuits are further configured to:
perform the multi-dimensional fast number theoretic transform of the target dimension on the input matrix, wherein the multi-dimensional fast number theoretic transform converts matrix-vector multiplication into a multi-stage computation architecture of the matrix multiplication calculation through a plurality of sub-calculations, one computing circuit performs one sub-calculation, and each of the sub-calculations is located at one stage of the multi-stage computation architecture.

3. The processing system related to encryption according to claim 2, wherein:
in response to the target dimension being two-dimensional, a mathematical expression of the multi-dimensional fast number theoretic transform is:
$${X}_{{N}_{2} {k}_{1} + {k}_{2}} = {\sum }_{{n}_{1} = 0}^{{N}_{1} - 1} ( ( {\sum }_{{n}_{2} = 0}^{{N}_{2} - 1} {{x}_{{N}_{1} {n}_{2} + {n}_{1}} ( {ω}^{2 {k}_{2} + 1} )}^{{N}_{1} {n}_{2}} ) {ω}^{{n}_{1} ( 2 {k}_{2} + 1 - {N}_{2} )} ) {( {ω}^{2 {k}_{1} + 1} )}^{{N}_{2} {n}_{1}}$$
where X_{N}_{₂}ₖ_{₁}₊ₖ_{₂} is an output factor of the (N₂k₁+k₂)-th multi-dimensional fast number theoretic transform, x_{N}_{₁}ₙ_{₂}₊ₙ_{₁} is the (N₁n₂+n₁)-th input matrix, ω is a twiddle factor, N₁·N₂ is N², and N is a degree of the polynomial.

4. The processing system related to encryption according to claim 3, wherein the computing circuits comprise at least one stage conversion circuit, a first twiddle circuit, and a transposition circuit, a sub-computation of the at least one stage conversion circuit is a butterfly computation, a sub-computation of the first twiddle circuit is a multiplication computation of the twiddle factor, and a sub-computation of the transposition circuit is factor position swapping.

5. The processing system related to encryption according to claim 2, wherein:
in response to the target dimension being three-dimensional, a mathematical expression of the multi-dimensional fast number theoretic transform is:
$${X}_{{N}_{3} {N}_{2} {k}_{1} + {N}_{3} {k}_{2} + {k}_{3}} = {{\sum }^{{N}_{1} - 1}}_{{n}_{1} = 0} ( {{\sum }^{{N}_{2} - 1}}_{{n}_{2} = 0} ( \begin{matrix}( {{\sum }^{{N}_{3} - 1}}_{{n}_{3} = 0} {x}_{{N}_{1} {N}_{2} {n}_{3} + {N}_{1} {n}_{2} + {n}_{1}} {{ω}^{{N}_{1} {N}_{2} {n}_{3}} ( {ω}^{2 {k}_{3}} )}^{{N}_{1} {N}_{2} {n}_{3}} ) \\ {( {ω}^{2 {k}_{3} + 1} )}^{{N}_{1} {N}_{2} + {n}_{1}} {( {ω}^{2 {k}_{2}} )}^{{N}_{3} {N}_{1} {n}_{2}}\end{matrix} ) ) {( {ω}^{2 {N}_{3} {k}_{2}} )}^{{N}_{1} {n}_{2} + {n}_{1}} {( {ω}^{2 {k}_{1}} )}^{{N}_{3} {N}_{2} {n}_{1}}$$
where X_{N}_{₃}_{N}_{₂}ₖ_{₁}_{+N}_{₃}ₖ_{₂}₊ₖ_{₃} is an output factor of the (N₃N₂k₁+N₃k₂+k₃)-th multi-dimensional fast number theoretic transform, x_{N}_{₁}_{N}_{₂}ₙ_{₃}_{+N}_{₁}ₙ_{₂}₊ₙ_{₁} is the (N₁N₂n₃+N₁n₂+n₁)-th input matrix, ω is a twiddle factor, N₁·N₂·N₃ is N³, and N is a degree of the polynomial.

6. The processing system related to encryption according to claim 5, wherein the computing circuits comprise at least one first twiddle circuit, at least one second twiddle circuit, at least one stage conversion circuit, a transposition circuit, and at least one memory transposition circuit, sub-computations of the at least one first twiddle circuit and the at least one second twiddle circuit are multiplication computations of the twiddle factor, a sub-computation of the at least one stage conversion circuit is a butterfly computation, a sub-computation of the transposition circuit is factor position swapping, and a sub-computation of the at least one memory transposition circuit is memory address change.

7. The processing system related to encryption according to claim 2, wherein:
in response to the target dimension being four-dimensional, a mathematical expression of the multi-dimensional fast number theoretic transform is:
$${X}_{{N}_{4} {N}_{3} {N}_{2} {k}_{1} + {N}_{4} {N}_{3} {k}_{2} + {N}_{4} {k}_{3} + {k}_{4}} = {{\sum }^{{N}_{2} - 1}}_{{n}_{2} = 0} ( {{\sum }^{{N}_{3} - 1}}_{{n}_{3} = 0} ( \begin{matrix}( {{\sum }^{{N}_{4} - 1}}_{{n}_{4} = 0} {x}_{{N}_{4} {N}_{3} {N}_{2} {k}_{1} + {N}_{4} {N}_{3} {k}_{2} + {N}_{4} {k}_{3} + {k}_{4}} {{ω}^{{N}_{1} {N}_{2} {N}_{3} {n}_{4}} ( {ω}^{2 {k}_{4}} )}^{{N}_{1} {N}_{2} {N}_{3} {n}_{4}} ) \\ {( {ω}^{2 {k}_{4} + 1} )}^{{N}_{1} {N}_{2} {n}_{3} + {N}_{1} {n}_{2} + {n}_{1}} {( {ω}^{2 {k}_{3}} )}^{{N}_{4} {N}_{2} {N}_{1} {n}_{3}}\end{matrix} ) ) {( {ω}^{2 {N}_{4} {k}_{3}} )}^{{N}_{1} {N}_{2} {n}_{3} + {N}_{1} {n}_{2} + {n}_{1}} {( {ω}^{2 {k}_{2}} )}^{{N}_{4} {N}_{3} {N}_{1} {n}_{3}} {( {ω}^{2 {N}_{4} {N}_{3} {k}_{2}} )}^{{N}_{1} {n}_{2} + {n}_{1}} {( {ω}^{2 {k}_{1}} )}^{{N}_{4} {N}_{3} {N}_{2} {n}_{1}}$$
where X_{N}_{₄}_{N}_{₃}_{N}_{₂}ₖ_{₁}_{+N}_{₄}_{N}_{₃}ₖ_{₂}_{+N}_{₄}ₖ_{₃}₊ₖ_{₄} is an output factor of the (N₄N₃N₂k₁+N₄N₃k₂+N₄k₃+k₄)-th multi-dimensional fast number theoretic transform, x_{N}_{₄}_{N}_{₃}_{N}_{₂}ₖ_{₁}_{+N}_{₄}_{N}_{₃}ₖ_{₂}_{+N}_{₄}ₖ_{₃}₊ₖ_{₄} is the (N₄N₃N₂k₁+N₄N₃k₂+N₄k₃+k₄)-th input matrix, ω is a twiddle factor, N₁·N₂·N₃·N₄ is N⁴, and N is a degree of the polynomial.

8. The processing system related to encryption according to claim 7, wherein the computing circuits comprise at least one first twiddle circuit, at least one stage conversion circuit, at least one transposition circuit, and at least one memory transposition circuit, a sub-computation of the at least one first twiddle circuit is a multiplication computation of the twiddle factor, a sub-computation of the at least one stage conversion circuit is a butterfly computation, a sub-computation of the at least one transposition circuit is factor position swapping, and a sub-computation of the at least one memory transposition circuit is memory address change.

9. The processing system related to encryption according to claim 2, wherein:
a mathematical expression of the multi-dimensional fast number theoretic transform is:
$${X}_{{k}_{1} , {k}_{2} , … , {k}_{d}} = {{\sum }^{{N}_{1} - 1}}_{{n}_{1} = 0} ( {ω}_{{N}_{1}}^{{k}_{1} {n}_{1}} {{\sum }^{{N}_{2} - 1}}_{{n}_{2} = 0} {ω}_{{N}_{2}}^{{k}_{2} {n}_{2}} … {{\sum }^{{N}_{d} - 1}}_{{n}_{d} = 0} {ω}_{{N}_{d}}^{{k}_{d} {n}_{d}} \cdot {x}_{{n}_{1} , {n}_{2} , … , {n}_{d}} )$$
where Xₖ_{₁}_{, k}_{₂} _{, . . . , k}_{_{d}} is an output factor of (k₁, k₂, . . . , k_{d})-th multi-dimensional fast number theoretic transform, xₙ_{₁}_{, n}_{₂} _{, . . . , n}_{_{d}} is (n₁, n₂, . . . , n_{d})-th input matrix, ω is a twiddle factor, N₁·N₂· . . . ·N_{d} is N^{d}, and N is a degree of the polynomial.

10. The processing system related to encryption according to claim 2, wherein the computing circuits comprise a stage conversion circuit and a memory circuit, a sub-computation of the stage conversion circuit is a butterfly computation, and a sub-computation of the memory circuit is to store data to the at least one memory.

11. A method related to encryption, comprising:
performing a fast number theoretic transform calculation on a polynomial through a plurality of computing circuits, comprising:
performing a matrix multiplication calculation on the polynomial through the fast number theoretic transform calculation.

12. The method related to encryption according to claim 11, wherein the fast number theoretic transform calculation is multi-dimensional fast number theoretic transform, a plurality of elements of an input matrix are factors of the polynomial, and performing the matrix multiplication calculation on the polynomial through the fast number theoretic transform calculation comprises:
performing the multi-dimensional fast number theoretic transform of a target dimension on the input matrix through the computing circuits, wherein the target dimension is greater than one dimension, the multi-dimensional fast number theoretic transform converts a matrix-vector multiplication into a multi-stage computation architecture of the matrix multiplication calculation through a plurality of sub-calculations, one computing circuit performs one sub-calculation, and each of the sub-calculations is located at one stage of the multi-stage computation architecture.

13. The method related to encryption according to claim 12, wherein performing the multi-dimensional fast number theoretic transform of the target dimension on the input matrix through the computing circuits comprises:
in response to the target dimension being two-dimensional, determining a mathematical expression of the multi-dimensional fast number theoretic transform as:
$${X}_{{N}_{2} {k}_{1} + {k}_{2}} = {\sum }_{{n}_{1} = 0}^{{N}_{1} - 1} ( ( {\sum }_{{n}_{2} = 0}^{{N}_{2} - 1} {{x}_{{N}_{1} {n}_{2} + {n}_{1}} ( {ω}^{2 {k}_{2} + 1} )}^{{N}_{1} {n}_{2}} ) {ω}^{{n}_{1} ( 2 {k}_{2} + 1 - {N}_{2} )} ) {( {ω}^{2 {k}_{1} + 1} )}^{{N}_{2} {n}_{1}}$$
where X_{N}_{₂}ₖ_{₁}₊ₖ_{₂} is an output factor of the (N₂k₁+k₂)-th multi-dimensional fast number theoretic transform, x_{N}_{₁}ₙ_{₂}₊ₙ_{₁} is the (N₁n₂+n₁)-th input matrix, ω is a twiddle factor, N₁·N₂ is N², and N is a degree of the polynomial.

14. The method related to encryption according to claim 13, wherein the computing circuits comprise at least one stage conversion circuit, a first twiddle circuit, and a transposition circuit, the method further comprising:
performing a butterfly computation through the at least one stage conversion circuit;
performing a multiplication computation of the twiddle factor through the first twiddle circuit; and
performing factor position swapping through the transposition circuit.

15. The method related to encryption according to claim 12, wherein performing the multi-dimensional fast number theoretic transform of the target dimension on the input matrix through the computing circuits comprises:
in response to the target dimension being three-dimensional, determining a mathematical expression of the multi-dimensional fast number theoretic transform as:
$${X}_{{N}_{3} {N}_{2} {k}_{1} + {N}_{3} {k}_{2} + {k}_{3}} = {{\sum }^{{N}_{1} - 1}}_{{n}_{1} = 0} ( {{\sum }^{{N}_{2} - 1}}_{{n}_{2} = 0} ( \begin{matrix}( {{\sum }^{{N}_{3} - 1}}_{{n}_{3} = 0} {x}_{{N}_{1} {N}_{2} {n}_{3} + {N}_{1} {n}_{2} + {n}_{1}} {{ω}^{{N}_{1} {N}_{2} {n}_{3}} ( {ω}^{2 {k}_{3}} )}^{{N}_{1} {N}_{2} {n}_{3}} ) \\ {( {ω}^{2 {k}_{3} + 1} )}^{{N}_{1} {N}_{2} + {n}_{1}} {( {ω}^{2 {k}_{2}} )}^{{N}_{3} {N}_{1} {n}_{2}}\end{matrix} ) ) {( {ω}^{2 {N}_{3} {k}_{2}} )}^{{N}_{1} {n}_{2} + {n}_{1}} {( {ω}^{2 {k}_{1}} )}^{{N}_{3} {N}_{2} {n}_{1}}$$
where X_{N}_{₃}_{N}_{₂}ₖ_{₁}_{+N}_{₃}ₖ_{₂}₊ₖ_{₃} is an output factor of the (N₃N₂k₁+N₃k₂+k₃)-th multi-dimensional fast number theoretic transform, x_{N}_{₁}_{N}_{₃}ₙ_{₃}_{+N}_{₁}ₙ_{₂}₊ₙ_{₁} is the (N₁N₂n₃+N₁n₂+n₁)-th input matrix, ω is a twiddle factor, N₁·N₂·N₃ is N³, and N is a degree of the polynomial.

16. The method related to encryption according to claim 15, wherein the computing circuits comprise at least one first twiddle circuit, at least one second twiddle circuit, at least one stage conversion circuit, a transposition circuit, and at least one memory transposition circuit, the method further comprising:
performing a multiplication computation of the twiddle factor through the at least one first twiddle circuit and the at least one second twiddle circuit;
performing a butterfly computation through the at least one stage conversion circuit;
performing factor position swapping through the transposition circuit; and
performing memory address change through the memory transposition circuit.

17. The method related to encryption according to claim 12, wherein performing the multi-dimensional fast number theoretic transform of the target dimension on the input matrix through the computing circuits comprises:
in response to the target dimension being four-dimensional, determining a mathematical expression of the multi-dimensional fast number theoretic transform as:
$${X}_{{N}_{4} {N}_{3} {N}_{2} {k}_{1} + {N}_{4} {N}_{3} {k}_{2} + {N}_{4} {k}_{3} + {k}_{4}} = {{\sum }^{{N}_{2} - 1}}_{{n}_{2} = 0} ( {{\sum }^{{N}_{3} - 1}}_{{n}_{3} = 0} ( \begin{matrix}( {{\sum }^{{N}_{4} - 1}}_{{n}_{4} = 0} {x}_{{N}_{4} {N}_{3} {N}_{2} {k}_{1} + {N}_{4} {N}_{3} {k}_{2} + {N}_{4} {k}_{3} + {k}_{4}} {{ω}^{{N}_{1} {N}_{2} {N}_{3} {n}_{4}} ( {ω}^{2 {k}_{4}} )}^{{N}_{1} {N}_{2} {N}_{3} {n}_{4}} ) \\ {( {ω}^{2 {k}_{4} + 1} )}^{{N}_{1} {N}_{2} {n}_{3} + {N}_{1} {n}_{2} + {n}_{1}} {( {ω}^{2 {k}_{3}} )}^{{N}_{4} {N}_{2} {N}_{1} {n}_{3}}\end{matrix} ) ) {( {ω}^{2 {N}_{4} {k}_{3}} )}^{{N}_{1} {N}_{2} {n}_{3} + {N}_{1} {n}_{2} + {n}_{1}} {( {ω}^{2 {k}_{2}} )}^{{N}_{4} {N}_{3} {N}_{1} {n}_{3}} {( {ω}^{2 {N}_{4} {N}_{3} {k}_{2}} )}^{{N}_{1} {n}_{2} + {n}_{1}} {( {ω}^{2 {k}_{1}} )}^{{N}_{4} {N}_{3} {N}_{2} {n}_{1}}$$
where X_{N}_{₄}_{N}_{₃}_{N}_{₂}ₖ_{₁}_{+N}_{₄}_{N}_{₃}ₖ_{₂}_{+N}_{₄}ₖ_{₃}₊ₖ_{₄} is an output factor of the (N₄N₃N₂k₁+N₄N₃k₂+N₄k₃+k₄)-th multi-dimensional fast number theoretic transform, x_{N}_{₄}_{N}_{₃}_{N}_{₂}ₖ_{₁}_{+N}_{₄}_{N}_{₃}ₖ_{₂}_{+N}_{₄}ₖ_{₃}₊ₖ_{₄} is the (N₄N₃N₂k₁+N₄N₃k₂+N₄k₃+k₄)-th input matrix, ω is a twiddle factor, N₁·N₂·N₃·N₄ is N⁴, and N is a degree of the polynomial.

18. The method related to encryption according to claim 17, wherein the computing circuits comprise at least one first twiddle circuit, at least one stage conversion circuit, at least one transposition circuit, and at least one memory transposition circuit, the method comprising:
performing a multiplication computation of the twiddle factor through the at least one first twiddle circuit;
performing a butterfly computation through the at least one stage conversion circuit;
performing factor position swapping through the at least one transposition circuit; and
performing memory address change through the at least one memory transposition circuit.

19. The method related to encryption according to claim 12, wherein:
a mathematical expression of the multi-dimensional fast number theoretic transform is:
$${X}_{{k}_{1} , {k}_{2} , … , {k}_{d}} = {{\sum }^{{N}_{1} - 1}}_{{n}_{1} = 0} ( {ω}_{{N}_{1}}^{{k}_{1} {n}_{1}} {{\sum }^{{N}_{2} - 1}}_{{n}_{2} = 0} {ω}_{{N}_{2}}^{{k}_{2} {n}_{2}} … {{\sum }^{{N}_{d} - 1}}_{{n}_{d} = 0} {ω}_{{N}_{d}}^{{k}_{d} {n}_{d}} \cdot {x}_{{n}_{1} , {n}_{2} , … , {n}_{d}} )$$
where Xₖ_{₁}_{, k}_{₂} _{, . . . , k}_{_{d}} is an output factor of (k₁, k₂, . . . , k_{d})-th multi-dimensional fast number theoretic transform, xₙ_{₁}_{, n}_{₂} _{, . . . , n}_{_{d}} is (n₁, n₂, . . . , n_{d})-th input matrix, ω is a twiddle factor, N₁·N₂· . . . ·N_{d} is N^{d}, and N is a degree of the polynomial.

20. The method related to encryption according to claim 12, wherein the computing circuits comprise a stage conversion circuit and a memory circuit, the method further comprising:
performing a butterfly computation through the stage conversion circuit; and
storing data to at least one memory through the memory circuit.
